(19) United States
(12) Patent Application Publication
(10) Pub. No.: US 2026/0107957 A1
(43) Pub. Date: Apr. 23, 2026

(54) USE OF AN EMULSIFIER DERIVED FROM RICINOLEIC ACID TO INCREASE THE ABSORPTION OF CALCIUM AND PHOSPHORUS IN THE DIGESTIVE TRACT OF FARM ANIMALS

(71) Applicant: GFS INDUSTRIA DE ALIMENTAÇÃO ANIMAL LTDA, Apucarana (BR)

(72) Inventors: JOSÉ LUCIANO ANDRIGUETTO, Curitiba (BR); VALDEMIR VIECINSKI, Curitiba (BR)

(21) Appl. No.: 19/113,337

(22) PCT Filed: Jul. 24, 2024
(86) PCT No.: PCT/IB2024/000396

§ 371 Date: Mar. 19, 2025

Related U.S. Application Data
(60) Provisional application No. 63/515,564, filed on Jul. 25, 2023.
(60) Provisional application No. 63/673,155, filed on Jul. 18, 2024.

(51) Int. Cl. A23K 20/158; A23K 20/24; A23K 50/10; A23K 50/30; A23K 50/60; A23K 50/75; A23K 50/80; A23L 29/10; A23L 33/12

(52) U.S. Cl. CPC A23K 20/158; A23K 20/24; A23K 50/10; A23K 50/30; A23K 50/60; A23K 50/75; A23K 50/80; A23L 29/10; A23L 33/12

(57) ABSTRACT

The present disclosure describes the use of an emulsifier derived from ricinoleic acid to increase the absorption of calcium and phosphorus in the digestive tract of farm animals. Additionally, the present disclosure provides a composition and a dietary formulation containing an emulsifier derivative of ricinoleic acid and its production method.

### CROSS-REFERENCE TO RELATED APPLICATIONS

This application claims the benefit of U.S. Patent Application No. 63/515,564, filed Jul. 25, 2023, and U.S. Patent Application No. 63/673,155, filed Jul. 18, 2024, each of which is incorporated herein by reference in its entirety for all purposes.

### BACKGROUND OF THE INVENTION

Calcium and phosphorus are essential nutrients for the health and good performance of farm animals. Although most of the ingredients of plant and animal origin that make up the diet of these animals contain varying amounts of calcium and phosphorus, in general, the needs of the animal are not met only through such ingredients, and therefore it is routinely necessary to supplement in the balanced diets of farm animals.

In most diets, it is sought to achieve an approximate level of 0.4% of total diet of available phosphorus, from an amount of total phosphorus around 0.5 to 0.65%. Considering the amount and digestibility of phosphorus present in the macroingredients (energy and protein sources), there is usually around 0.1% of phosphorus available. With the use of state-of-the-art phytases, 0.2 to 0.25% of available phosphorus can be achieved. So, in general, 20 to 60 kg of phosphates or meat and bone meal per ton of feed are used as sources of the missing 0.15 to 0.2% of phosphorous.

In general, the phospholipids found in food have digestibility greater than 90%, but are present in very low amounts, representing less than 5% of total phosphorus. In addition, its absorption may be affected by other factors, such as the hepatic secretion of bile salts, or by the use of emulsifying additives added to feed.

Currently, one way to compensate for the losses that occur in the digestive process is the use of higher levels of calcium and phosphorus in the rations of farm animals. However, with this, the feeding of farm animals competes with other sectors, such as food intended for pet feeding and agriculture, for the availability of increasingly expensive raw materials, such as meat and bone meal and phosphates.

In addition to the greater demand for these ingredients, there is also the issue of the environmental impact caused by the amount of phosphorus present in animal waste. Excess phosphorus in the soil and especially in water bodies negatively affects the physicochemical balance of the environment, leading to the phenomenon known as eutrophication, with exaggerated growth of unwanted organisms such as algae. In several countries, there is also specific legislation on the amount of phosphorus, nitrogen, and potassium that an animal production area can release in the form of waste, given the limited disposal of these wastes.

Another technical problem to be considered is the origin of phosphorus present in phosphates. The manufacture of phosphates involves the mining of phosphate rocks, which are subsequently treated with sulfuric acid. This is manufactured from sulfur extracted from mines. Both sulfur and phosphate rock mines have productivity limits, which is not sustainable resources.

Although many countries, including Brazil, have important reserves of phosphate rock, local production often becomes insufficient to meet the demand of animal production and agriculture, and it is necessary to import phosphorus. Globally, there are few sulfur mines, which significantly increases the cost of sulfuric acid. Thus, the cost of, for example. Brazilian agricultural production is vulnerable to the international availability of these commodities and the fluctuation of the exchange rate.

Thus, the improvement of the absorption of phosphorus and calcium by the farm animals has a high impact on the economy of production, on the reduction of the demand for important raw materials for other sectors, on the environmental impact of the activity and on the price of food of animal origin. However, there is currently no product in the animal feed market focused on such maximization.

The option for the exogenous enzyme phytase breaks down the phytate molecule, releasing the phosphate ions into the light of the digestive tract, but improves the likelihood that these ions will be absorbed, that is, that it will cross the wall of the intestine and reach the bloodstream. These ions can simply interact with calcium ions, forming insoluble salts, and ending up in excreta. The effect of phytases is variable and dependent on various dietary factors. The nutritional matrix of phytases varies greatly with the brand and the chemical nature of the same, with values of phosphorus, calcium, metabolizable energy, protein, and amino acids.

The option for the use of other emulsifiers presents only the effect of improvement in the absorption of lipids, without interacting significantly with the calcium ions and, mainly, of phosphorus of the diet. This can be evidenced by the nutritional matrices of these additives currently available in the market, which cite only their effect on the absorption of energy from diets.

Although the use of ricinoleic acid and its derivatives as an emulsifier is known and applied in the human food industry, especially confectionery and other industrialized foods, this application is always linked to the objective of improving the miscibility of fats with substances of a polar nature, in aqueous medium, improving the sensory aspects of the food, and never to the objective of maximizing the absorption of calcium and phosphorus. This concern is usually not present in the formulation of processed foods. In addition, although these emulsifiers have their use approved in animal feed, it would only aim to increase the absorption of fat/energy from the diet.

### SUMMARY

The present disclosure provides methods of feeding an animal, comprising providing to the animal a diet, the diet comprises a feed source and a nutritional supplement: the nutritional supplement comprises: (a) an emulsifier solution; and (c) optionally one or more carriers, the emulsifier solution comprises: (i) an emulsifier, said emulsifier comprising a compound or salt thereof having the structural formula of Formula (I), or a salt thereof:

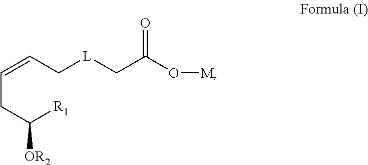

R₁ is C₁-C₇ alkyl, which is optionally substituted with one or more C₁-C₇ alkyl; R₂ is hydrogen, sodium, or calcium; M is a cation selected from the group consisting of Ca, Na, Li, P, and Mg; and L is C₂-C₇ alkyl, which is optionally substituted with one or more groups selected from C₁-C₇ alkyl and —OH; (ii) sodium hydroxide (NaOH); and (iii) optionally water; the feed source comprises less calcium or phosphorous than a control feed source without the emulsifier, the animal consuming the feed source comprising less calcium or phosphorous and the emulsifier solution displays the same or enhanced level of at least one nutrition indicator relative to the animal consuming the control feed source without the emulsifier solution; and the diet comprises less than about 0.2 percent of the emulsifier by weight of the diet.

In some embodiments, in Formula (I), the compound is further defined as:

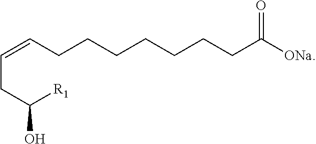

In some embodiments, in Formula (I), the compound is further defined as:

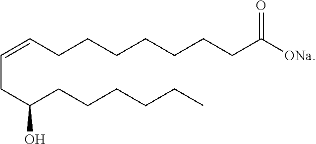

In some embodiments, the compound of Formula (I) is in the form of a calcium salt, a sodium salt, a lithium salt, a phosphorus salt, a potassium salt, a magnesium salt, a zinc salt, a manganese salt, a copper salt, an iron salt, a cobalt salt, or any combination thereof. In some embodiments, the compound of Formula (I) is in the form of a calcium or sodium salt. In some embodiments, the emulsifier solution is present in the amount of about 0.1 percent to 100 percent by weight of the nutritional supplement. In some embodiments, the emulsifier solution is present in the amount of about 0.1 percent to 50 percent by weight of the nutritional supplement. In some embodiments, the emulsifier solution is present in the amount of about 5 percent to 40 percent by weight of the nutritional supplement. In some embodiments, the emulsifier solution is present in the amount of about 10 percent to 30 percent by weight of the nutritional supplement. In some embodiments, the emulsifier solution is present in the amount of about 15 percent to 25 percent by weight of the nutritional supplement. In some embodiments, the emulsifier solution is present in the amount of about 20 percent by weight of the nutritional supplement. In some embodiments, the emulsifier solution comprises about 0.1 to about 99 percent of the compound of Formula (I), about 0.1 to 99 percent sodium hydroxide, and about 0 to about 99 percent water by weight of the emulsifier solution. In some embodiments, the emulsifier solution comprises about 1 to about 50 percent of the compound of Formula (I), about 1 to about 25 percent sodium hydroxide, and about 25 to about 99 percent water by weight of the emulsifier solution. In some embodiments, the emulsifier solution comprises about 1 to about 50 percent of the compound of Formula (I), about 1 to about 10 percent sodium hydroxide, and about 25 to about 99 percent water by weight of the emulsifier solution. In some embodiments, the emulsifier solution comprises about 24 percent of the compound of Formula (I), about 3 percent sodium hydroxide, and about 74 percent water by weight of the emulsifier solution. In some embodiments, the emulsifier solution comprises about 23.63 percent of the compound of Formula (I), about 2.55 percent sodium hydroxide, and about 73.83 percent water by weight of the emulsifier solution. In some embodiments, the emulsifier solution comprises about 50 to 100 percent of the compound of Formula (I), about 0 to 10 percent sodium hydroxide, and about 0 to about 10 percent water by weight of the emulsifier solution. In some embodiments, the emulsifier solution comprises about 75 to about 99 percent of the compound of Formula (I), about 1 to 5 percent sodium hydroxide, and about 0 percent water by weight of the emulsifier solution. In some embodiments, the nutritional supplement comprises the at least one or more carriers. In some embodiments, the at least one or more carriers comprises at least one or more sources of silica or at least one or more sources of calcium. In some embodiments, the one or more sources of silica comprises diatomaceous earth. In some embodiments, the one or more sources of silica is present in an amount of between about 0 and 99 percent by weight of the nutritional supplement. In some embodiments, the one or more sources of silica is present in an amount of about 0 to about 95 percent by weight of the nutritional supplement. In some embodiments, the one or more sources of silica is present in an amount of about 25 to about 45 percent by weight of the nutritional supplement. In some embodiments, the one or more sources of silica is present in an amount of about 30 to about 40 percent by weight of the nutritional supplement. In some embodiments, the one or more sources of silica is present in an amount of about 35 percent by weight of the nutritional supplement. In some embodiments, the one or more calcium sources comprises calcium carbonate. In some embodiments, the calcium carbonate comprises calcite. In some embodiments, the one or more sources of calcium is present in an amount of about 0 to about 99 percent by weight of the nutritional supplement. In some embodiments, the one or more sources of calcium is present in an amount of about 1 to about 50 percent by weight of the nutritional supplement. In some embodiments, the one or more sources of calcium is present in an amount of about 10 to about 50 percent by weight of the nutritional supplement. In some embodiments, the one or more sources of calcium is present in an amount of about 40 to about 50 percent by weight of the nutritional supplement. In some embodiments, the one or more sources of calcium is present in an amount of about 45 percent by weight of the nutritional supplement. In some embodiments, the carrier comprises at least one silica sources and at least one calcium sources. In some embodiments, the feed source is animal feed. In some embodiments, the animal feed comprises poultry feed, swine feed, aquatic animal feed, or ruminant feed. In some embodiments, in the feed source is appropriate for human consumption. In some embodiments, the nutritional supplement is present in a ratio of the nutritional supplement to the feed source of about 0.1 kg of nutritional supplement per ton of the feed source to about 2 kg of the nutritional supplement per ton of the feed source. In some embodiments, the nutritional supplement is present in a ratio of the nutritional supplement to the feed source of about 0.2 kg of nutritional supplement per ton of the feed source to about 1.5 kg of the nutritional supplement per ton of the feed source. In some embodiments, the nutritional supplement is present in a ratio of the nutritional supplement to the feed source of about 0.5 kg nutritional supplement per ton of the feed source to about 1 kg of the nutritional supplement per ton of the feed source. In some embodiments, the feed source further comprises water. In some embodiments, the nutritional supplement is present at about 0.001 to about 1 percent weight relative to the weight of the feed source. In some embodiments, the nutritional supplement is present at about 0.01 to about 0.5 percent weight relative to the weight of the feed source. In some embodiments, the nutritional supplement is present at about 0.025 to about 0.1 percent weight relative to the weight of the feed source. In some embodiments, the feed source comprises 1 percent to 1.000 percent less calcium or phosphorous by weight of the feed source than the control feed source. In some embodiments, the feed source comprises 1 percent to 500 percent less calcium or phosphorous by weight of the control feed source. In some embodiments, the feed source comprises 1 percent to 200 percent less calcium or phosphorous by weight of the control feed source. In some embodiments, the feed source comprises 1 percent to 100 percent less calcium or phosphorous by weight of the feed source than the control feed source. In some embodiments, the feed source comprises 1 percent to 50 percent less calcium or phosphorous by weight of the feed source than the control feed source. In some embodiments, the feed source comprises 1 percent to 25 percent less calcium or phosphorous by weight of the feed source than the control feed source. In some embodiments, the feed source comprises 1 percent to 10 percent less calcium or phosphorous by weight of the feed source than the control feed source. In some embodiments, the feed source comprises 1 percent to 5 percent less calcium or phosphorous by weight of the control feed source. In some embodiments, the feed source comprises 1 percent less calcium or phosphorous by weight of the feed source than the control feed source. In some embodiments, the feed source comprises 0.01 percent to 1 percent less calcium or phosphorous by weight of the feed source than the control feed source. In some embodiments, the feed source comprises less calcium and phosphorous by weight of the control the feed source. In some embodiments, the feed source does not contain meat or bone meal or dicalcium phosphate or any other source of phosphorus, such as Dicalcium Phosphate (DCP). Monocalcium Phosphate (MCP). Tricalcium Phosphate (TCP). Bone Meal. Meat and Bone Meal (MBM). Fish Meal, and Sodium Phosphate. In some embodiments, the at least one nutrition indicator comprises weight gain, egg shell quality, carcass yield, average live weight, average carcass weight, bone fracture healing rate, blood serum calcium or phosphate levels, decreased levels of calcium or phosphate in excreta, bone radiopacity, egg production, egg quality, feed conversion rate, daily weight gain, final litter weight, meat quality score, average weight daily gain, feed efficiency, body condition score, ionized calcium levels, vitamin D levels, reproductive parameters, fertility, prolificity, ease of birth, reduction of problems associated with pregnancy, reduction of problems associated with delivery, reduction in issues with prolapses, reduction in issues with placenta retention, or any combination thereof. In some embodiments, the diet comprises less than about 0.1 percent of the emulsifier by weight of the diet. In some embodiments, the diet comprises less than about 0.01 percent of the emulsifier by weight of the diet. In some embodiments, the diet comprises about 0.0023 percent to 0.0046 percent of the emulsifier by weight of the diet. In some embodiments, the diet comprises about 0.00115 percent to 0.0056 percent of the emulsifier by weight of the diet. In some embodiments, the diet comprises 0.0035 percent of the emulsifier by weight of the diet. In some embodiments, the animal is provided the diet yearly. In some embodiments, the animal is provided the diet monthly. In some embodiments, the animal is provided the diet weekly. In some embodiments, the animal is provided the diet daily. In some embodiments, the animal is provided the twice daily. In some embodiments, the animal is provided the three times a day. In some embodiments, the animal is provided the diet four times a day. In some embodiments, the animal is provided the diet continuously. In some embodiments, the animal is provided the diet as needed. In some embodiments, the animal is provided the diet once.

Further described herein are methods of increasing bioavailability of phosphorous, calcium, or both, in a subject, the method comprising feeding the animal any of the diet, feed source, nutritional supplements, or any combination thereof as described herein. In some embodiments, the subject is an animal. In some embodiments, the animal is a ruminant, a poultry, a swine, a poultry, an aquatic animal, or a human. In some embodiments, the animal is a ruminant. The method of claim 76, wherein the ruminant is administered about 0.1 g to about 25 g of the nutritional supplement per day. In some embodiments, the ruminant is administered about 5 g to about 20 g of the nutritional supplement per day. In some embodiments, the ruminant is administered about 10 g to about 20 g of the nutritional supplement per day. In some embodiments, the ruminant is administered about 15 g of the nutritional supplement per day. In some embodiments, the ruminant is administered about 0.5 g of the nutritional supplement per day. In some embodiments, the ruminant is administered about 0.01 kg to about 60 kg of the diet per day. In some embodiments, the ruminant is administered about 0.1 g to about 60 g of the nutritional supplement per day. In some embodiments, the ruminant is administered about 0.1 kg to about 55 kg of the diet per day. In some embodiments, the ruminant is administered about 10 kg to about 55 kg of the diet per day. In some embodiments, the ruminant is administered about 25 kg to about 55 kg of the diet per day. In some embodiments, the ruminant is administered about 30 kg to about 50 kg of the diet per day. In some embodiments, the ruminant is administered about 0.5 g to about 15 g of the nutritional supplement per day. In some embodiments, the ruminant is administered about 0.1 kg to about 30 kg of the diet per day. In some embodiments, the ruminant is a steer, a beef producing ruminant, or a milk producing ruminant, a lamb, a sheep, a ram, a kid, a goat, a buck, or a small ruminant. In some embodiments, the method further increases the production of milk in the ruminant, increases the growth of meat in weight in the ruminant, or any combination thereof. In some embodiments, the method further increases the growth of meat in weight in the ruminant.

In some embodiments, the animal is a poultry. In some embodiments, the poultry is administered about 0.005 kg to about 0.2 kg of the diet per day. In some embodiments, the poultry is a broiler poultry, a laying hen, a breeding poultry, a quail, a duck, a mallard, or a turkey. In some embodiments, the method further increases the frequency of egg production, increases the egg quality, increases the growth of meat in weight in the poultry, increases the bone radiopacity in the poultry, increases bone strength in the poultry, or any combination thereof. In some embodiments, the increases in egg quality comprises increase in egg shell strength, egg shell thickness, or both. In some embodiments, the animal is a swine. In some embodiments, the swine is administered about 0.075 g to about 4.0 kg of the diet per day. In some embodiments, the swine is a sow, a piglet, a hog, a boar, or a gilt. In some embodiments, the method further increases the volume of milk produced by the swine, improves the quality of milk produced by the swine, increases the growth of meat in weight in the swine, or any combination thereof. In some embodiments, the subject is a human. In some embodiments, the human is administered about 0.1 g to about 3.5 g of the nutritional supplement per day. In some embodiments, the human is administered about 0.5 g to about 2.5 g of the nutritional supplement per day. In some embodiments, the human is administered about 1.5 g of the nutritional supplement per day. In some embodiments, the nutritional supplement is administered at least one daily. In some embodiments, the nutritional supplement is administered once to every 3 days. In some embodiments, the method further increases phosphorous concentration, increases calcium concentration, decreases ionized calcium concentration, alters vitamin D concentration in blood serum, or any combination thereof. In some embodiments, the phosphorus concentration in blood serum increases by about 0.1 mg/dL to about 2 mg/dL. In some embodiments, the phosphorus concentration in blood serum increases by about 0.3 mg/dL to about 1 mg/dL. In some embodiments, the phosphorus concentration in blood serum increases by about 1% to about 50%. In some embodiments, the phosphorus concentration in blood serum increases by about 10% to about 35%. In some embodiments, the calcium concentration in blood serum increases by about 0.1 mg/dL to about 5 mg/dL. In some embodiments, the calcium concentration in blood serum increases by about 0.2 mg/dL to about 0.3 mg/dL. In some embodiments, the calcium concentration in blood serum increases by about 0.1% to about 10%. In some embodiments, the calcium concentration in blood serum increases by about 2% to about 3%. In some embodiments, the ionized calcium concentration in blood serum increases by about 0.005% to about 0.01%. In some embodiments, the ionized calcium concentration in blood serum increases by about 0.007%.

Further described herein are methods of preparing a compound or salt thereof having the structural formula of Formula (I), comprising (a) mixing a compound or salt thereof having the structural formula of Formula (II) with a strong base comprising sodium hydroxide or a salt thereof, the strong base is between about 5 percent and 25 percent volume of a reaction mixture. Formula (II) is:

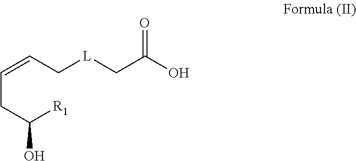

R¹ is C₁-C₇ alkyl, which is optionally substituted with one or more C₁-C₇ alkyl; and L is C₂-C₇ alkyl, which is optionally substituted with one or more groups selected from C₁-C₇ alkyl and —OH. In some embodiments, the methods of preparing a compound or salt thereof having the structural formula of Formula (I) further comprises a heating step between about 20° centigrade and 150° centigrade before step (a). In some embodiments, the strong base is selected from the group consisting of sodium hydroxide, lithium hydroxide, potassium hydroxide, calcium hydroxide, magnesium hydroxide, and any combination thereof. In some embodiments, the strong base of step (a) has a pH between 8 and 14. In some embodiments, the strong base of step (a) is present in a concentration of 5 to 25% of the total volume. In some embodiments, the strong base of step (a) is present between about 5 percent and about 30 percent of the concentration of the compound of Formula (II). In some embodiments, the concentration of the compound of Formula (II) in step (a) is from about 20 percent to about 75 percent by weight. In some embodiments, the mixing is performed in time between 5 and 30 minutes. Further described herein are emulsifiers for increased absorption of calcium or phosphorous, the emulsifier comprises, a compound or salt thereof having the structural formula of Formula (I), or a salt thereof:

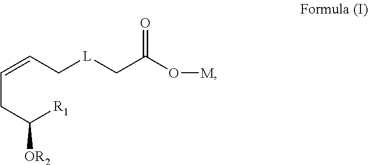

R₁ is C₁-C₇ alkyl, which is optionally substituted with one or more C₁-C₇ alkyl; R₂ is hydrogen or calcium; M is a cation selected from the group consisting of Ca, Na, Li, P, and Mg; and L is C₂-C₇ alkyl, which is optionally substituted with one or more groups selected from C₁-C₇ alkyl and —OH; (ii) sodium hydroxide (NaOH); and (iii) optionally water. In some embodiments, in Formula (I), the compound is further defined as:

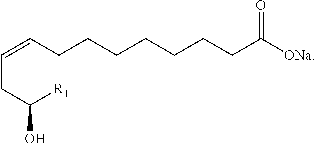

In some embodiments, in Formula (I), the compound is further defined as:

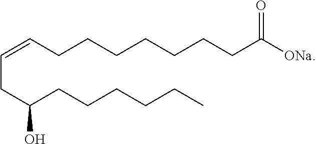

In some embodiments, the compound of Formula (I) is in the form of a calcium salt, a sodium salt, a lithium salt, a phosphorus salt, a potassium salt, a magnesium salt, a zinc salt, a manganese salt, a copper salt, an iron salt, a cobalt salt, or any combination thereof. In some embodiments, the compound of Formula (I) is in the form of a calcium or sodium salt. In some embodiments, the emulsifier comprises about 0.1 to about 99 percent of the compound of Formula (I), about 0.1 to 99 percent sodium hydroxide, and about zero to about 99 percent water by weight of the emulsifier. In some embodiments, the emulsifier comprises about 1 to about 50 percent of the compound of Formula (I), about 1 to 25 percent sodium hydroxide, and about 25 to about 99 percent water by weight of the emulsifier solution. In some embodiments, the emulsifier comprises about 1 to 50 percent of the compound of Formula (I), about 1 to 10 percent sodium hydroxide, and about 25 to about 99 percent water by weight of the emulsifier. In some embodiments, the emulsifier comprises about 24 percent of the compound of Formula (I), about 3 percent sodium hydroxide, and about 74 percent water by weight of the emulsifier. In some embodiments, the emulsifier comprises about 23.63 percent of the compound of Formula (I), about 2.55 percent sodium hydroxide, and about 73.83 percent water by weight of the emulsifier. In some embodiments, the emulsifier comprises about 50 to 99 percent of the compound of Formula (I), about 1 to 10 percent sodium hydroxide, and about 0 to about 10 percent water by weight of the emulsifier. In some embodiments, the emulsifier solution comprises about 75 to about 99 percent of the compound of Formula (I), about 1 to about 5 percent sodium hydroxide, and about 0 percent water by weight of the emulsifier.

Further described herein are nutritional supplements for increased calcium or phosphorous absorption, the nutritional supplement comprises at least one emulsifier as described herein and optionally at least one or more carriers. In some embodiments, the emulsifier is present in the amount of about 0.1 percent to about 100 percent by weight of the nutritional supplement. In some embodiments, the emulsifier is present in the amount of about 0.1 percent to about 50 percent by weight of the nutritional supplement. In some embodiments, the emulsifier is present in the amount of about 5 percent to about 40 percent by weight of the nutritional supplement. In some embodiments, the emulsifier is present in the amount of about 10 percent to about 30 percent by weight of the nutritional supplement. In some embodiments, the emulsifier is present in the amount of about 15 percent to about 25 percent by weight of the nutritional supplement. In some embodiments, the emulsifier is present in the amount of about 20 percent by weight of the nutritional supplement. In some embodiments, the nutritional supplement comprises the at least one or more carriers. In some embodiments, the at least one or more carriers comprises at least one or more sources of silica or at least one or more sources of calcium. In some embodiments, the one or more sources of silica comprises diatomaceous earth. In some embodiments, the one or more sources of silica is present in an amount of between about 0 and about 99 percent by weight of the nutritional supplement. In some embodiments, the one or more sources of silica is present in an amount of about 0 to about 95 percent by weight of the nutritional supplement. In some embodiments, the one or more sources of silica is present in an amount of about 25 to about 45 percent by weight of the nutritional supplement. In some embodiments, the one or more sources of silica is present in an amount of about 30 to about 40 percent by weight of the nutritional supplement. In some embodiments, the one or more sources of silica is present in an amount of about 35 percent by weight of the nutritional supplement. In some embodiments, the one or more calcium sources comprises calcium carbonate. In some embodiments, the calcium carbonate comprises calcite. In some embodiments, the one or more sources of calcium is present in an amount of about 0 to about 99 percent by weight of the nutritional supplement. In some embodiments, the one or more sources of calcium is present in an amount of about 1 to about 50 percent by weight of the nutritional supplement. In some embodiments, the one or more sources of calcium is present in an amount of about 10 to about 50 percent by weight of the nutritional supplement. In some embodiments, the one or more sources of calcium is present in an amount of about 40 to about 50 percent by weight of the nutritional supplement. In some embodiments, the one or more sources of calcium is present in an amount of about 45 percent by weight of the nutritional supplement. In some embodiments, the carrier comprises at least one silica sources and at least one calcium sources.

Further described herein are methods of enhancing calcium and phosphate absorption in a subject, comprising the administration of an effective amount of an emulsifier as described herein or a nutritional supplement as described herein to a subject. In some embodiments, the method bypasses the regulation of calcium and phosphate absorption by calcitonin, parathormone, vitamin D3, or any combination thereof. In some embodiments, the subject is a farm animal, a pet, or a human. In some embodiments, where the enhanced phosphate absorption provides benefits including improving bone health, increasing energy levels, improving metabolic function, supporting growth and development in children, supporting fetal growth and maternal metabolism during gestation and lactation, supporting bone health, supporting longevity in the elderly, enhancement of performance and recovery in athletes, or any combination thereof.

Described herein are uses of an emulsifier as described herein or a nutritional supplement as described herein for the manufacture of a composition for enhancing phosphate absorption in a subject.

Described herein are methods of making a nutritional supplement comprising mixing an emulsifier as described herein with at least one carrier, optionally at room temperature.

Described herein are uses of an emulsifier as described herein or a nutritional supplement for the manufacture of a composition for enhancing at least one nutrition indicator in a subject. In some embodiments, the subject is an animal, a pet, a livestock, or a human.

Described herein are methods of obtaining a compound or salt thereof having the structural formula of Formula (I), comprising: (a) mixing a compound or salt thereof having the structural formula of Formula (II) sodium hydroxide in a pH neutral medium at room temperature. Formula (II) is:

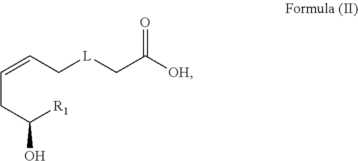

R¹ is C₁-C₇ alkyl, which is optionally substituted with one or more C₁-C₇ alkyl; and L is C₂-C₇ alkyl, which is optionally substituted with one or more groups selected from C₁-C₇ alkyl and —OH.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure may be obtained by reference to the following detailed description that sets forth illustrative embodiments, in which the principles of the disclosure are utilized, and the accompanying drawings of which:

FIG. 1 shows the result of the litters according to the treatment that the sows received as described herein.

FIG. 2 shows the result of the litters according to the treatment that the sows received as described herein.

FIG. 3 shows changes in phosphorus levels over the study period.

FIG. 4 shows changes in serum calcium levels over the study period.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Introduction

The present disclosure provides a composition and a diet formulation containing an emulsifier derived from ricinoleic acid. In addition, the present disclosure refers to the said composition and the use of the emulsifier derived from ricinoleic acid to maximize the absorption of calcium and phosphorus in the digestive tract of farm animals.

Disclosed herein is an emulsifier comprising a compound of Formula (I). The emulsifier disclosed herein increases the absorption of calcium and phosphorus present in the macro ingredients of animal feed, such as corn and soy bean meal, dispensing with the use of additional sources of phosphorus, such as meat and bone meal and dicalcium phosphate. Additional sources of calcium may still be needed, but in smaller amounts. In this way, the nutritional value of these ingredients, which are already used as a source of energy and protein, is maximized. In addition, the emulsifying action, combined with the lower use of a complex ingredient, such as meat and bone meal, increases the net energy of the diet, that is, it allows a much more efficient use of the energy of the feed, improving feed conversion. The greater energy availability also allows for better immune response and greater longevity of the animals. The emulsifier also provides the reduction of the risk of microbiological contamination by meat and bone meal. This represents a minimization of sanitary challenges, as a gateway of possible contaminants is closed, allowing a decrease in the use of medicines (antibiotics) and a healthy economic activity, contributing to better animal welfare.

With the use of the present invention, it is possible to make available a greater amount of the total phosphorus present in the macroingredients, reaching the requirement of 0.4% of available phosphorus, without the need to include phosphates or meals.

The enhanced phosphate absorption provides benefits including improving bone health, increasing energy levels, improving metabolic function, supporting growth and development in children, supporting fetal growth and maternal metabolism during gestation and lactation, supporting bone health, supporting longevity in the elderly, and enhancement of performance and recovery in athletes.

In addition to all the direct benefits obtained from the emulsifier, the present disclosure allows the elimination of animal meal from the formulations, which brings the following benefits: exclusion of bone fragments that can cause failures in the feed distribution systems to the animals, which could generate a disruption in the feed supply, reduction of the proliferation of pests, such as rodents in feed mills, contributing directly to a healthier environment for the farm animal and the employee, and more safety for the consumer, optimization of the cost of feed, by dispensing with the inclusion of additional raw materials, reduction of vulnerability to cost variation of phosphorus sources from other sectors, such as the reduction in the slaughter of cattle, affecting the production of meat and bone meal, the increase in the demand for these meals by the petfood market, the increase in the demand for phosphate by agriculture or the exchange rate variation, and reduction of the need for built physical space. This economy, combined with the reduction of up to 40% in the volume of raw materials, significantly reduces the carbon footprint of the activity. Additional benefits may include reduction of excretion of much of the calcium and phosphorus ingested, avoiding environmental contamination. In aquatic animal feed, the present disclosure may have less impact on the phenomenon of eutrophication, due to the lower amount of phosphorus included in the diets, but also can improve agility in processing in feed mills, saving energy, time and labor, facilitating the management of phosphorus for small producers, enabling small-scale production with great social impact. The present disclosure provides greater security of supply and price since the producer can stock without compromising space and time for its superior validity to animal meal. The present disclosure creates a possibility of providing a product 100% free of cross-contamination of other species, with reduced health risk to the consumer, such as bovine spongiform encephalitis (mad cow).

Disclosed herein is the use of an emulsifier derived from ricinoleic acid to maximize the absorption of calcium and phosphorus in the digestive tract of farm animals. Additionally, the present disclosure provides a composition. The composition is a nutritional supplement which serves as a calcium and phosphorus absorption optimizer. A nutritional supplement of the present application may form part of, or all of, the diet formulation in the diet of an animal. The nutritional supplement contains the derived emulsifier, ricinoleic acid and may be produced by methods of production disclosed herein.

The present disclosure provides a composition and the use of this to maximize the absorption of calcium and phosphorus in the digestive tract of farm animals, pets, and humans. In addition, the use of an emulsifier derived from ricinoleic acid is provided for the formulation of this nutritional supplement composition and its manufacturing method. In this way, the present disclosure allows the complete or partial exclusion of supplementary phosphorus sources from the diets of farm animals, and the significant reduction of calcium sources, providing an alternative to replace meat and bone meal in feed. Disclosed herein is a nutritional matrix of up to 200% total calcium, up to 200% digestible calcium, up to 200% total phosphorus, up to 200% digestible or available phosphorus, and up to 48,000 kcal of metabolizable energy.

The present disclosure improves the use of emulsifiers with the innovative and specific purpose of maximizing the absorption of calcium and phosphorus, including the creation of a nutritional matrix that contemplates the levels of calcium, phosphorus, and energy to be considered in the formulation of diets, via the use of the emulsifier. From the application of this nutritional matrix, the possibility of excluding additional sources of calcium and phosphorus, such as phosphates and meat and bone meal, is evident. In some embodiments, the feed source does not contain any other source of phosphorus, such as. Dicalcium Phosphate (DCP), Monocalcium Phosphate (MCP), Tricalcium Phosphate (TCP), Bone Meal, Meat and Bone Meal (MBM), Fish Meal, and Sodium Phosphate.

The present disclosure contemplates the use of an emulsifier derived from ricinoleic acid, with high activity in the absorption of calcium and phosphorus in the digestive tract of farm animals. This emulsifier is a mixture of fatty acid or ricinoleic acid salts, of high molecular weight, obtained from the saponification reaction of ricinoleic acid with a strong base, at high temperature. The hydroxyl and carboxyl endings of the derivative of ricinoleic acid of the present disclosure react with the calcium and phosphorus ions, preventing them from binding in the form of insoluble salts, and allowing their absorption in the form of lipid micelles. In some embodiments, the ricinoleic acid derivative has a chemical structure:

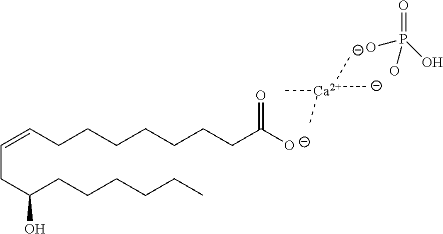

The ricinoleic acid derivative disclosed herein has a strong emulsifying effect, which intensifies the formation of small micelles in the light of the digestive tract, which maximizes the absorption of lipids from the diet. When micelles form, the emulsifier drags calcium and phosphorus ions along with them, maximizing the absorption of minerals. In other words, the calcium and phosphorus that would otherwise be lost are thus absorbed in the form of phospholipids, throughout the small intestine.

The application of the present disclosure in the formulation of diets of farm animals is possible thanks to the development of the nutritional matrix of the emulsifier. It brings the corresponding levels of calcium, phosphorus and metabolizable energy that the animals will absorb from the ingredients of the diet, with the use of the emulsifier. These values are applied in animal feed formula optimization programs, so that it is included in the calculation of the digestible amount of each of the nutrients. By optimizing the dietary formulation, the animal feed can exclude phosphates and meat and bone meal, meeting the requirements of the animals through only the phosphorus of the other dietary formulation, such as corn and soybean meal. Depending on the species and animal category, additional sources of calcium may be required. In some cases, limestone is used as an extremely low-cost source of calcium.

The present disclosure also refers to a composition to increase the absorption of calcium and phosphorus in the digestive tract of farm animals that comprises: an emulsifier derived from ricinoleic acid, a mineral source of calcium, and a source of silica in solid form. In some cases, the emulsifier comprises ricinoleic acid, one or more mineral sources of calcium, and one or more mineral sources of phosphorous.

### Emulsifier, Nutritional Supplement Composition, and Emulsifier Production

Disclosed herein are emulsifier solutions comprising an emulsifier and sodium hydroxide (NaOH). In some embodiments, the emulsifier solution further comprises water. In some embodiments, the emulsifier comprises a compound or salt thereof having the structural formula of Formula (I), or a salt thereof:

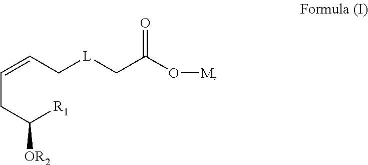

wherein,
R₁ is C₁-C₇ alkyl, which is optionally substituted with one or more C₁-C₇ alkyl;
R₂ is hydrogen or calcium;
M is a cation selected from the group consisting of Ca, Na, Li, P, and Mg; and
L is C₂-C₇ alkyl, which is optionally substituted with one or more groups selected from C₁-C₇ alkyl and —OH.

In some embodiments, described herein are methods of obtaining a compound or salt thereof having the structural formula of Formula (I), comprising: (a) mixing a compound or salt thereof having the structural formula of Formula (II) sodium hydroxide in a pH neutral medium at room temperature, wherein Formula (II) is:

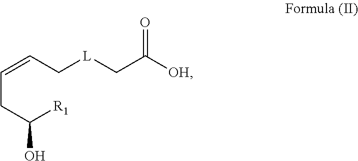

wherein, R¹ is C₁-C₇ alkyl, which is optionally substituted with one or more C₁-C₇ alkyl; and L is C₂-C₇ alkyl, which is optionally substituted with one or more groups selected from C₁-C₇ alkyl and —OH.

In some embodiments, the compound of Formula (I) is at least about 70% pure.

In some embodiments, the compound of Formula (I) is:

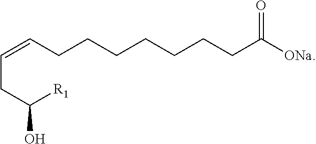

In some embodiments, the compound of Formula (I) is:

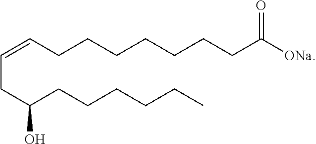

In some embodiments, R₁ is C₁-C₇ alkyl, which is optionally substituted with one or more C₁-C₇ alkyl. In some embodiments, R₁ is C₁ alkyl (e.g., methyl). In some embodiments, R₁ is C₂ alkyl (e.g., ethyl). In some embodiments, R₁ is C₃ alkyl (e.g., propyl, isopropyl). In some embodiments, R₁ is C₄ alkyl (e.g., butyl, n-butyl, t-butyl). In some embodiments, R₁ is C₅ alkyl (e.g., pentyl, n-pentyl). In some embodiments, R₁ is C₆ alkyl (e.g., hexyl, n-hexyl). In some embodiments, R₁ is C₇ alkyl (e.g., heptyl, n-heptyl). In some embodiments, R₁ is substituted with one or more C₁-C₇ alkyl. In some embodiments, R₁ is substituted with one C₁-C₇ alkyl. In some embodiments, R₁ is substituted with two C₁-C₇ alkyl. In some embodiments, R₁ is substituted with three C₁-C₇ alkyl. In some embodiments, R₂ is hydrogen and calcium. In some embodiments, R₂ is hydrogen. In some embodiments, R₂ is-calcium. In some embodiments, M is a cation selected from the group consisting of Ca, Na, Li, P, and Mg. In some embodiments, Mis a cation of Ca (calcium). In some embodiments, M is a cation of Na (sodium). In some embodiments, M is a cation of Li (lithium). In some embodiments, M is a cation of P (phosphorus). In some embodiments, M is a cation of Mg (magnesium). In some embodiments, Lis C₁-C₇ alkyl, which is optionally substituted with one or more C₁-C₇ alkyl. In some embodiments, Lis C₁ alkyl (e.g., methyl). In some embodiments, Lis C₂ alkyl (e.g., ethyl). In some embodiments, L is C₃ alkyl (e.g., propyl, isopropyl). In some embodiments, L is C₄ alkyl (e.g., butyl, n-butyl, t-butyl). In some embodiments, L is C₅ alkyl (e.g., pentyl, n-pentyl). In some embodiments, L is C₆ alkyl (e.g., hexyl, n-hexyl). In some embodiments, L is C₇ alkyl (e.g., heptyl, n-heptyl). In some embodiments, L is substituted with one C₁-C₇ alkyl. In some embodiments, L is substituted with two C₁-C₇ alkyl. In some embodiments, L is substituted with three C₁-C₇ alkyl. In some embodiments, L is substituted with one —OH. In some embodiments. L is substituted with two —OH. In some embodiments. L is substituted with three —OH.

In some embodiments, the compound of Formula (I) is at least about 70% pure to about 99.9% pure. In some embodiments, the compound of Formula (I) is at least about 70% pure to about 75% pure, about 70% pure to about 80% pure, about 70% pure to about 85% pure, about 70% pure to about 90% pure, about 70% pure to about 95% pure, about 70% pure to about 98% pure, about 70% pure to about 99% pure, about 70% pure to about 99.9% pure, about 75% pure to about 80% pure, about 75% pure to about 85% pure, about 75% pure to about 90% pure, about 75% pure to about 95% pure, about 75% pure to about 98% pure, about 75% pure to about 99% pure, about 75% pure to about 99.9% pure, about 80% pure to about 85% pure, about 80% pure to about 90% pure, about 80% pure to about 95% pure, about 80% pure to about 98% pure, about 80% pure to about 99% pure, about 80% pure to about 99.9% pure, about 85% pure to about 90% pure, about 85% pure to about 95% pure, about 85% pure to about 98% pure, about 85% pure to about 99% pure, about 85% pure to about 99.9% pure, about 90) % pure to about 95% pure, about 90% pure to about 98% pure, about 90% pure to about 99% pure, about 90% pure to about 99.9% pure, about 95% pure to about 98% pure, about 95% pure to about 99% pure, about 95% pure to about 99.9% pure, about 98% pure to about 99% pure, about 98% pure to about 99.9% pure, or about 99% pure to about 99.9% pure.

In some embodiments, the compound of Formula (I) is at least about 70% pure, about 75% pure, about 80% pure, about 85% pure, about 90% pure, about 95% pure, about 98% pure, about 99% pure, or about 99.9% pure. In some embodiments, the compound of Formula (I) is at least at least about 70% pure, about 75% pure, about 80% pure, about 85% pure, about 90% pure, about 95% pure, about 98% pure, or about 99% pure.

In some embodiments, the compound of Formula (I) is at least at most about 75% pure, about 80% pure, about 85% pure, about 90% pure, about 95% pure, about 98% pure, about 99% pure, or about 99.9% pure.

In some embodiments, the compound of Formula (I) is at least about 70% pure, about 75% pure, about 80% pure, about 85% pure, about 90% pure, about 95% pure, about 98% pure, about 99% pure, or about 99.9% pure.

In some embodiments, the compound of Formula (I) is in the form of a calcium salt, a sodium salt, a lithium salt, a phosphorus salt, a potassium salt, a magnesium salt, a zinc salt, a manganese salt, a copper salt, an iron salt, a cobalt salt, or any combination thereof. In some embodiments, the compound of Formula (I) is in the form of a calcium salt, a sodium salt, a lithium salt, a phosphorus salt, a potassium salt, a magnesium salt, a zinc salt, a manganese salt, a copper salt, an iron salt, a cobalt salt, or any combination thereof. In some embodiments, the compound of Formula (I) is in the form of a calcium salt. In some embodiments, the compound of Formula (I) is in the form of a sodium salt. In some embodiments, the compound of Formula (I) is in the form of a lithium salt. In some embodiments, the compound of Formula (I) is in the form of a phosphorus salt. In some embodiments, the compound of Formula (I) is in the form of a potassium salt. In some embodiments, the compound of Formula (I) is in the form of a magnesium salt. In some embodiments, the compound of Formula (I) is in the form of a zinc salt. In some embodiments, the compound of Formula (I) is in the form of a manganese salt. In some embodiments, the compound of Formula (I) is in the form of a copper salt. In some embodiments, the compound of Formula (I) is in the form of an iron salt. In some embodiments, the compound of Formula (I) is in the form of a cobalt salt.

In some embodiments, the emulsifier solution comprises about 0.1 to about 99 percent of the compound of Formula (I) by weight of the emulsifier solution. In some embodiments, the emulsifier solution comprises about 1 to about 50 percent of the compound of Formula (I) by weight of the emulsifier solution. In some embodiments, the emulsifier solution comprises about 24 percent of the compound of Formula (I) by weight of the emulsifier solution. In some embodiments, the emulsifier solution comprises about 23.63 percent of the compound of Formula (I) by weight of the emulsifier solution. In some embodiments, the emulsifier solution comprises about 50 to about 100 percent of the compound of Formula (I) by weight of the emulsifier solution. In some embodiments, the emulsifier solution comprises about 75 to about 99 percent of the compound of Formula (I) by weight of the emulsifier solution.

In some embodiments, the emulsifier solution comprises about 0.1 to about 20 percent of the compound of Formula (I) by weight of the emulsifier solution. In some embodiments, the emulsifier solution comprises about 1 to about 20 percent of the compound of Formula (I) by weight of the emulsifier solution. In some embodiments, the emulsifier solution comprises about 1 to about 15 percent of the compound of Formula (I) by weight of the emulsifier solution. In some embodiments, the emulsifier solution comprises about 1 to about 10 percent of the compound of Formula (I) by weight of the emulsifier solution. In some embodiments, the emulsifier solution comprises about 20 to about 80 percent of the compound of Formula (I) by weight of the emulsifier solution. In some embodiments, the emulsifier solution comprises about 20 to about 40 percent of the compound of Formula (I) by weight of the emulsifier solution. In some embodiments, the emulsifier solution comprises about 20 to about 60 percent of the compound of Formula (I) by weight of the emulsifier solution. In some embodiments, the emulsifier solution comprises about 40 to about 80 percent of the compound of Formula (I) by weight of the emulsifier solution. In some embodiments, the emulsifier solution comprises about 60 to about 80 percent of the compound of Formula (I) by weight of the emulsifier solution. In some embodiments, the emulsifier solution comprises about 0.1 to about 0.5 percent of the compound of Formula (I) by weight of the emulsifier solution. In some embodiments, the emulsifier solution comprises about 1 to about 20 percent of the compound of Formula (I) by weight of the emulsifier solution. In some embodiments, the emulsifier solution comprises about 1 to about 15 percent of the compound of Formula (I) by weight of the emulsifier solution. In some embodiments, the emulsifier solution comprises about 1 to about 10 percent of the compound of Formula (I) by weight of the emulsifier solution. In some embodiments, the emulsifier solution comprises about 0.1 to about 1 percent of the compound of Formula (I) by weight of the emulsifier solution. In some embodiments, the emulsifier solution comprises about 0.1 to about 5 percent of the compound of Formula (I) by weight of the emulsifier solution. In some embodiments, the emulsifier solution comprises about 0.1 to about 10 percent of the compound of Formula (I) by weight of the emulsifier solution. In some embodiments, the compound of Formula (I) is present in an amount of between about 1 to about 20 percent of the compound of Formula (I) by weight of the emulsifier solution. In some embodiments, the compound of Formula (I) is present in an amount of between about 1 to about 15 percent of the compound of Formula (I) by weight of the emulsifier solution. In some embodiments, the compound of Formula (I) is present in an amount of between about 1 to about 10 percent of the compound of Formula (I) by weight of the emulsifier solution.

In some embodiments, the emulsifier solution comprises about 1 percent, about 2 percent, about 3 percent, about 4 percent, about 5 percent, about 6 percent, about 7 percent, about 8 percent, about 9) percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent of the compound of Formula (I) by weight of the emulsifier solution.

In some embodiments, the emulsifier solution comprises about 0.1 to about 99 percent sodium hydroxide by weight of the emulsifier solution. In some embodiments, the emulsifier solution comprises about 1 to about 25 percent sodium hydroxide by weight of the emulsifier solution. In some embodiments, the emulsifier solution comprises about 1 to about 10 percent sodium hydroxide by weight of the emulsifier solution. In some embodiments, the emulsifier solution comprises about 3 percent sodium hydroxide by weight of the emulsifier solution. In some embodiments, the emulsifier solution comprises about 2.55 percent sodium hydroxide by weight of the emulsifier solution. In some embodiments, the emulsifier solution comprises about 1 to about 5 percent sodium hydroxide by weight of the emulsifier solution.

In some embodiments, the emulsifier solution comprises about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, or about 99 percent sodium hydroxide by weight of the emulsifier solution.

In some embodiments, the emulsifier solution comprises about 0 to about 99 percent water by weight of the emulsifier solution. In some embodiments, the emulsifier solution comprises about 25 to about 99 percent water by weight of the emulsifier solution. In some embodiments, the emulsifier solution comprises about 74 percent water by weight of the emulsifier solution. In some embodiments, the emulsifier solution comprises about 73.83 percent water by weight of the emulsifier solution. In some embodiments, the emulsifier solution comprises about 0 to about 10 percent water by weight of the emulsifier solution. In some embodiments, the emulsifier solution comprises about 0 percent water by weight of the emulsifier solution. In some embodiments, the emulsifier solution does not comprise water.

In some embodiments, the emulsifier solution comprises about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, or about 99 percent water by weight of the emulsifier solution.

In some embodiments, disclosed herein is a method of preparing a compound or salt thereof having the structural formula of Formula (I), comprising: (a) mixing a compound or salt thereof having the structural formula of Formula (II) with a strong base comprising hydroxide or a salt thereof, wherein the strong base is between about 5 percent and 25 percent volume of a reaction mixture, wherein Formula

(II) is:

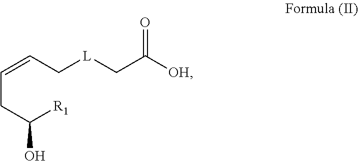

wherein, R¹ is C₁-C₇ alkyl, which is optionally substituted with one or more C₁-C₇ alkyl; and L is C₂-C₇ alkyl, which is optionally substituted with one or more groups selected from C₁-C₇ alkyl and —OH.

In some embodiments, the method further comprising a heating step between about 20° and 150° before step (a).

In some embodiments, the mixing is done at a temperature between about 0° C. and 25° C. In some embodiments, the mixing is done at a temperature between about 10° C., and 25° C. In some embodiments, the mixing is done at a temperature between about −10° C., and 25° C. In some embodiments, the mixing is done at a temperature between about 0° C. and 25° C. In some embodiments, the mixing is done at a temperature between about −20° C., and 25° C. In some embodiments, the mixing is done at a temperature between about 0° C. and 35° C. In some embodiments, the mixing is done at a temperature between about 0° C. and 45° C. In some embodiments, the method further comprises a heating step between about 20° and 150°.

In some embodiments, the carrier is selected from: one or more sources of lime, one or more sources of silica, sodium chloride, one or more fibrous sources, dextrose, one or more carbohydrates, lactose, or a combination thereof.

In some embodiments, the strong base is selected from the group consisting of sodium hydroxide, lithium hydroxide, potassium hydroxide, or any combination thereof.

In some embodiments, the strong base of step (a) has a pH between 8 and 14. In some embodiments, the strong base of step (a) has a pH between 11 and 14. In some embodiments, the strong base of step (a) has a pH between 11 and 13. In some embodiments, the strong base of step (a) has a pH between 11 and 12. In some embodiments, the strong base of step (a) has a pH between 12 and 14. In some embodiments, the strong base of step (a) has a pH between 11 and 12. In some embodiments, the strong base of step (a) has a pH between 12 and 13.

In some embodiments, the strong base of step (a) is present in a concentration of 5% to 25% of the total volume. In some embodiments, the strong base of step (a) is present in a concentration of 5% to 15% of the total volume. In some embodiments, the strong base of step (a) is present in a concentration of 15% to 25% of the total volume.

In some embodiments, the strong base of step (a) is present between about 15 percent and about 30 percent of the concentration of the compound of Formula (II).

In some embodiments, the concentration of the compound of Formula (II) in step (a) is from about 20 percent to about 75 percent by weight. In some embodiments, the concentration of the compound of Formula (II) in step (a) is from about 40 percent to about 75 percent by weight. In some embodiments, the concentration of the compound of Formula (II) in step (a) is from about 50 percent to about 75 percent by weight. In some embodiments, the concentration of the compound of Formula (II) in step (a) is from about 60 percent to about 75 percent by weight.

In some embodiments, the mixing is performed in time between 5 and 30 minutes. In some embodiments, the mixing is performed in time between 5 and 60 minutes. In some embodiments, the mixing is performed in time between 10 and 30 minutes. In some embodiments, the mixing is performed in time between 15 and 30 minutes. In some embodiments, the mixing is performed in time between 5 and 15 minutes.

### Diet and Diet Compositions, Nutritional Supplement and Production

Described herein are diets or diet compositions. In some embodiments, the diets or diet compositions comprises a feed source and a nutritional supplement.

In some embodiments, the nutritional supplement is a calcium and phosphorus absorption optimizer. In some embodiments, the nutritional supplement comprises an emulsifier solution.

In some embodiments, the emulsifier solution is present in the amount of about 0.1 percent to 100 percent by weight of the nutritional supplement. In some embodiments, the emulsifier solution is present in the amount of about 0.1 percent to 50 percent by weight of the nutritional supplement. In some embodiments, the emulsifier solution is present in the amount of about 5 percent to 40 percent by weight of the nutritional supplement. In some embodiments, the emulsifier solution is present in the amount of about 10 percent to 30 percent by weight of the nutritional supplement. In some embodiments, the emulsifier solution is present in the amount of about 15 percent to 25 percent by weight of the nutritional supplement. In some embodiments, the emulsifier solution is present in the amount of about 20 percent by weight of the nutritional supplement.

In some embodiments the emulsifier solution is present in an amount of about 20 to about 80 percent by weight of the nutritional supplement.

In some embodiments, the emulsifier solution is present in the amount of about 1 to about 100 percent, about 2 to about 100 percent, about 3 to about 100 percent, about 4 to about 100 percent, about 5 to about 100 percent, about 6 to about 100 percent, about 7 to about 100 percent, about 8 to about 100 percent, about 9 to about 100 percent, about 10 to about 100 percent, about 15 to about 100 percent, about 20 to about 100 percent, about 25 to about 100 percent, about 30 to about 100 percent, about 35 to about 100 percent, about 40 to about 100 percent, about 45 to about 100 percent, about 50 to about 100 percent, about 55 to about 100 percent, about 60 to about 100 percent, about 65 to about 100 percent, about 70 to about 100 percent, about 75 to about 100 percent, about 80 to about 100 percent, about 85 to about 100 percent, about 90 to about 100 percent, about 95 to about 100 percent, about 50 to about 95 percent, about 55 to about 95 percent, about 60 to about 95 percent, about 65 to about 95 percent, about 70 to about 95 percent, about 75 to about 95 percent, about 80 to about 95 percent, about 85 to about 95 percent, about 90 to about 95 percent, about 95 to about 95 percent, about 50 to about 90 percent, about 55 to about 90 percent, about 60 to about 90 percent, about 65 to about 90 percent, about 70 to about 90 percent, about 75 to about 90 percent, about 80 to about 90 percent, or about 85 to about 90 percent by weight of the nutritional supplement.

In some embodiments, the emulsifier solution is present in the amount of about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent, by weight of the nutritional supplement.

In some embodiments, the nutritional supplement further comprises one or more carriers.

In some embodiments, a carrier is selected from one or more sources of lime; one or more sources of: silica, or both; one or more fibrous sources; or a combination thereof. In some embodiments, the one or more carriers comprises at least one or more sources of silica or at least one or more sources of calcium. In some embodiments, the one or more carriers comprises at least one or more sources of silica and at least one or more sources of calcium.

In some embodiments, the one or more carriers is present in an amount of between about 1 to about 60 percent, about 2 to about 60 percent, about 3 to about 60 percent, about 4 to about 60 percent, about 5 to about 60 percent, about 6 to about 60 percent, about 7 to about 60 percent, about 8 to about 60 percent, about 9 to about 60 percent, about 10 to about 60 percent, about 15 to about 60 percent, about 20 to about 60 percent, about 25 to about 60 percent, about 30 to about 60 percent, about 35 to about 60 percent, about 40 to about 60 percent, about 45 to about 60 percent, about 50 to about 60 percent, about 55 to about 60 percent, about 1 to about 55 percent, about 2 to about 55 percent, about 3 to about 55 percent, about 4 to about 55 percent, about 5 to about 55 percent, about 6 to about 55 percent, about 7 to about 55 percent, about 8 to about 55 percent, about 9 to about 55 percent, about 10 to about 55 percent, about 15 to about 55 percent, about 20 to about 55 percent, about 25 to about 55 percent, about 30 to about 55 percent, about 35 to about 55 percent, about 40 to about 55 percent, about 45 to about 55 percent, about 1 to about 50 percent, about 2 to about 50 percent, about 3 to about 50 percent, about 4 to about 50 percent, about 5 to about 50 percent, about 6 to about 50 percent, about 7 to about 50 percent, about 8 to about 50 percent, about 9 to about 50 percent, about 10 to about 50 percent, about 15 to about 50 percent, about 20 to about 50 percent, about 25 to about 50 percent, about 30 to about 50 percent, about 35 to about 50 percent, about 40 to about 50 percent, about 45 to about 50 percent, about 1 to about 45 percent, about 2 to about 45 percent, about 3 to about 45 percent, about 4 to about 45 percent, about 5 to about 45 percent, about 6 to about 45 percent, about 7 to about 45 percent, about 8 to about 45 percent, about 9 to about 45 percent, about 10 to about 45 percent, about 15 to about 45 percent, about 20 to about 45 percent, about 25 to about 45 percent, about 30 to about 45 percent, about 35 to about 45 percent, about 40 to about 45 percent, about 1 to about 40 percent, about 2 to about 40 percent, about 3 to about 40 percent, about 4 to about 40 percent, about 5 to about 40 percent, about 6 to about 40 percent, about 7 to about 40 percent, about 8 to about 40 percent, about 9 to about 40 percent, about 10 to about 40 percent, about 15 to about 40 percent, about 20 to about 40 percent, about 25 to about 40 percent, about 30 to about 40 percent, or about 35 to about 40 percent by weight of the nutritional supplement.

In some embodiments, the at least one carrier is present in the amount of about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent, by weight of the nutritional supplement.

In some embodiments, the one or more sources of silica comprises diatomaceous earth.

In some embodiments, the one or more sources of silica is present in an amount of between about 0 and 99 percent by weight of the nutritional supplement. In some embodiments, the one or more sources of silica is present in an amount of between about 0 and 95 percent by weight of the nutritional supplement. In some embodiments, the one or more sources of silica is present in an amount of between about 30 and 40 percent by weight of the nutritional supplement. In some embodiments, the one or more sources of silica is present in an amount of between about 30 to about 40 percent by weight of the nutritional supplement.

In some embodiments, the one or more sources of silica is present in an amount of between about 1 to about 60 percent, about 2 to about 60 percent, about 3 to about 60 percent, about 4 to about 60 percent, about 5 to about 60 percent, about 6 to about 60 percent, about 7 to about 60 percent, about 8 to about 60 percent, about 9 to about 60 percent, about 10 to about 60 percent, about 15 to about 60 percent, about 20 to about 60 percent, about 25 to about 60 percent, about 30 to about 60 percent, about 35 to about 60 percent, about 40 to about 60 percent, about 45 to about 60 percent, about 50 to about 60 percent, about 55 to about 60 percent, about 1 to about 55 percent, about 2 to about 55 percent, about 3 to about 55 percent, about 4 to about 55 percent, about 5 to about 55 percent, about 6 to about 55 percent, about 7 to about 55 percent, about 8 to about 55 percent, about 9 to about 55 percent, about 10 to about 55 percent, about 15 to about 55 percent, about 20 to about 55 percent, about 25 to about 55 percent, about 30 to about 55 percent, about 35 to about 55 percent, about 40 to about 55 percent, about 45 to about 55 percent, about 1 to about 50 percent, about 2 to about 50 percent, about 3 to about 50 percent, about 4 to about 50 percent, about 5 to about 50 percent, about 6 to about 50 percent, about 7 to about 50 percent, about 8 to about 50 percent, about 9 to about 50 percent, about 10 to about 50 percent, about 15 to about 50 percent, about 20 to about 50 percent, about 25 to about 50 percent, about 30 to about 50 percent, about 35 to about 50 percent, about 40 to about 50 percent, about 45 to about 50 percent, about 1 to about 45 percent, about 2 to about 45 percent, about 3 to about 45 percent, about 4 to about 45 percent, about 5 to about 45 percent, about 6 to about 45 percent, about 7 to about 45 percent, about 8 to about 45 percent, about 9 to about 45 percent, about 10 to about 45 percent, about 15 to about 45 percent, about 20 to about 45 percent, about 25 to about 45 percent, about 30 to about 45 percent, about 35 to about 45 percent, about 40 to about 45 percent, about 1 to about 40 percent, about 2 to about 40 percent, about 3 to about 40 percent, about 4 to about 40 percent, about 5 to about 40 percent, about 6 to about 40 percent, about 7 to about 40 percent, about 8 to about 40 percent, about 9 to about 40 percent, about 10 to about 40 percent, about 15 to about 40 percent, about 20 to about 40 percent, about 25 to about 40 percent, about 30 to about 40 percent, or about 35 to about 40 percent by weight of the nutritional supplement.

In some embodiments, the one or more sources of silica is present in the amount of about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent, by weight of the nutritional supplement.

In some embodiments, the one or more calcium sources comprises calcium carbonate. In some embodiments, the calcium carbonate comprises calcite.

In some embodiments, the one or more sources of calcium is present in an amount of about 0 to about 99 percent by weight of the nutritional supplement. In some embodiments, the one or more sources of calcium is present in an amount of about 1 to about 50 percent by weight of the nutritional supplement. In some embodiments, the one or more sources of calcium is present in an amount of about 10 to about 50 percent by weight of the nutritional supplement. In some embodiments, the one or more sources of calcium is present in an amount of about 40 to about 50 percent by weight of the nutritional supplement. In some embodiments, the one or more sources of calcium is present in an amount of about 45 percent by weight of the nutritional supplement.

In some embodiments, the one or more sources of silica is present in an amount of between about 1 to about 60 percent, about 2 to about 60 percent, about 3 to about 60 percent, about 4 to about 60) percent, about 5 to about 60 percent, about 6 to about 60 percent, about 7 to about 60 percent, about 8 to about 60 percent, about 9 to about 60 percent, about 10 to about 60 percent, about 15 to about 60 percent, about 20 to about 60 percent, about 25 to about 60 percent, about 30 to about 60 percent, about 35 to about 60 percent, about 40 to about 60 percent, about 45 to about 60 percent, about 50 to about 60 percent, about 55 to about 60 percent, about 1 to about 55 percent, about 2 to about 55 percent, about 3 to about 55 percent, about 4 to about 55 percent, about 5 to about 55 percent, about 6 to about 55 percent, about 7 to about 55 percent, about 8 to about 55 percent, about 9 to about 55 percent, about 10 to about 55 percent, about 15 to about 55 percent, about 20 to about 55 percent, about 25 to about 55 percent, about 30 to about 55 percent, about 35 to about 55 percent, about 40 to about 55 percent, about 45 to about 55 percent, about 1 to about 50 percent, about 2 to about 50 percent, about 3 to about 50 percent, about 4 to about 50 percent, about 5 to about 50 percent, about 6 to about 50 percent, about 7 to about 50 percent, about 8 to about 50 percent, about 9 to about 50 percent, about 10 to about 50 percent, about 15 to about 50 percent, about 20 to about 50 percent, about 25 to about 50 percent, about 30 to about 50 percent, about 35 to about 50 percent, about 40 to about 50 percent, about 45 to about 50 percent, about 1 to about 45 percent, about 2 to about 45 percent, about 3 to about 45 percent, about 4 to about 45 percent, about 5 to about 45 percent, about 6 to about 45 percent, about 7 to about 45 percent, about 8 to about 45 percent, about 9 to about 45 percent, about 10 to about 45 percent, about 15 to about 45 percent, about 20) to about 45 percent, about 25 to about 45 percent, about 30 to about 45 percent, about 35 to about 45 percent, about 40 to about 45 percent, about 1 to about 40 percent, about 2 to about 40 percent, about 3 to about 40 percent, about 4 to about 40 percent, about 5 to about 40 percent, about 6 to about 40 percent, about 7 to about 40 percent, about 8 to about 40 percent, about 9 to about 40 percent, about 10 to about 40 percent, about 15 to about 40 percent, about 20 to about 40 percent, about 25 to about 40 percent, about 30 to about 40 percent, or about 35 to about 40 percent by weight of the nutritional supplement.

In some embodiments, the one or more sources of silica is present in the amount of about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent, by weight of the nutritional supplement.

In some embodiments, the composition further comprises one or more sources of silica and one or more sources of calcium.

In some embodiments, the nutritional supplement further comprises water. In some embodiments, the nutritional supplement comprises water in an amount between about five percent to twenty percent by weight of the composition. In some embodiments, comprises essentially no water. In some embodiments, the nutritional supplement comprises less than 1 percent water by wight of the nutritional supplement. In some embodiments, the nutritional supplement comprises less than 0.01 percent water by weight of the nutritional supplement.

In some embodiments, water is present in an amount of between about 1 to about 60 percent, about 2 to about 60 percent, about 3 to about 60 percent, about 4 to about 60 percent, about 5 to about 60 percent, about 6 to about 60 percent, about 7 to about 60 percent, about 8 to about 60 percent, about 9 to about 60 percent, about 10 to about 60 percent, about 15 to about 60 percent, about 20 to about 60 percent, about 25 to about 60 percent, about 30 to about 60 percent, about 35 to about 60 percent, about 40 to about 60 percent, about 45 to about 60 percent, about 50 to about 60 percent, about 55 to about 60 percent, about 1 to about 55 percent, about 2 to about 55 percent, about 3 to about 55 percent, about 4 to about 55 percent, about 5 to about 55 percent, about 6 to about 55 percent, about 7 to about 55 percent, about 8 to about 55 percent, about 9 to about 55 percent, about 10 to about 55 percent, about 15 to about 55 percent, about 20 to about 55 percent, about 25 to about 55 percent, about 30 to about 55 percent, about 35 to about 55 percent, about 40 to about 55 percent, about 45 to about 55 percent, about 1 to about 50 percent, about 2 to about 50 percent, about 3 to about 50 percent, about 4 to about 50 percent, about 5 to about 50 percent, about 6 to about 50 percent, about 7 to about 50 percent, about 8 to about 50 percent, about 9 to about 50 percent, about 10 to about 50 percent, about 15 to about 50 percent, about 20 to about 50 percent, about 25 to about 50 percent, about 30 to about 50 percent, about 35 to about 50 percent, about 40 to about 50 percent, about 45 to about 50 percent, about 1 to about 45 percent, about 2 to about 45 percent, about 3 to about 45 percent, about 4 to about 45 percent, about 5 to about 45 percent, about 6 to about 45 percent, about 7 to about 45 percent, about 8 to about 45 percent, about 9 to about 45 percent, about 10 to about 45 percent, about 15 to about 45 percent, about 20 to about 45 percent, about 25 to about 45 percent, about 30 to about 45 percent, about 35 to about 45 percent, about 40 to about 45 percent, about 1 to about 40 percent, about 2 to about 40 percent, about 3 to about 40 percent, about 4 to about 40 percent, about 5 to about 40 percent, about 6 to about 40 percent, about 7 to about 40 percent, about 8 to about 40 percent, about 9 to about 40 percent, about 10 to about 40 percent, about 15 to about 40 percent, about 20 to about 40 percent, about 25 to about 40 percent, about 30 to about 40 percent, or about 35 to about 40 percent by weight of the nutritional supplement.

In some embodiments, water is present in the amount of about 1 percent, about 2 percent, about 3 percent, about 4 percent, about 5 percent, about 6 percent, about 7 percent, about 8 percent, about 9 percent, about 10 percent, about 11 percent, about 12 percent, about 13 percent, about 14 percent, about 15 percent, about 16 percent, about 17 percent, about 18 percent, about 19 percent, about 20 percent, about 21 percent, about 22 percent, about 23 percent, about 24 percent, about 25 percent, about 26 percent, about 27 percent, about 28 percent, about 29 percent, about 30 percent, about 31 percent, about 32 percent, about 33 percent, about 34 percent, about 35 percent, about 36 percent, about 37 percent, about 38 percent, about 39 percent, about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, about 60 percent, about 61 percent, about 62 percent, about 63 percent, about 64 percent, about 65 percent, about 66 percent, about 67 percent, about 68 percent, about 69 percent, about 70 percent, about 71 percent, about 72 percent, about 73 percent, about 74 percent, about 75 percent, about 76 percent, about 77 percent, about 78 percent, about 79 percent, about 80 percent, about 81 percent, about 82 percent, about 83 percent, about 84 percent, about 85 percent, about 86 percent, about 87 percent, about 88 percent, about 89 percent, about 90 percent, about 91 percent, about 92 percent, about 93 percent, about 94 percent, about 95 percent, about 96 percent, about 97 percent, about 98 percent, about 99 percent, or about 100 percent, by weight of the nutritional supplement.

In some embodiments, the emulsifier solution comprises about 0.1 to about 99 percent of the compound of Formula (I), about 0.1 to 99 percent sodium hydroxide, and about 0 to about 99 percent water by weight of the emulsifier solution.

In some embodiments, the emulsifier solution comprises about 1 to about 50 percent of the compound of Formula (I), about 1 to about 25 percent sodium hydroxide, and about 25 to about 99 percent water by weight of the emulsifier solution.

In some embodiments, the emulsifier solution comprises about 1 to about 50 percent of the compound of Formula (I), about 1 to about 10 percent sodium hydroxide, and about 25 to about 99 percent water by weight of the emulsifier solution.

In some embodiments, the emulsifier solution comprises about 24 percent of the compound of Formula (I), about 3 percent sodium hydroxide, and about 74 percent water by weight of the emulsifier solution.

In some embodiments, the emulsifier solution comprises about 23.63 percent of the compound of Formula (I), about 2.55 percent sodium hydroxide, and about 73.83 percent water by weight of the emulsifier solution.

In some embodiments, emulsifier solution comprises about 50 to 100 percent of the compound of Formula (I), about 0 to 10 percent sodium hydroxide, and about 0 to about 10 percent water by weight of the emulsifier solution.

In some embodiments, the emulsifier solution comprises about 75 to about 99 percent of the compound of Formula (I), about 1 to 5 percent sodium hydroxide, and about 0 percent water by weight of the emulsifier solution.

In some embodiments, the diet comprises less than about 0.1 percent of the emulsifier by weight of the diet. In some embodiments, the diet comprises less than about 0.01 percent of the emulsifier by weight of the diet. In some embodiments, the diet comprises about 0.0023 percent to 0.0046 percent of the emulsifier by weight of the diet. In some embodiments, the diet comprises about 0.00115 percent to 0.0056 percent of the emulsifier by weight of the diet. In some embodiments, the diet comprises 0.0035 percent of the emulsifier by weight of the diet.

In some embodiments, the diet comprises less than about 25 percent, less than about 20 percent, less than about 10 percent, less than about 9 percent, less than about 8 percent, less than about 7 percent, less than about 6 percent, less than about 5 percent, less than about 4 percent, less than about 3 percent, less than about 2 percent, less than about 1 percent, less than about 0.9 percent, less than about 0.8 percent, less than about 0.7 percent, less than about 0.6 percent, less than about 0.5 percent, less than about 0.4 percent, less than about 0.3 percent, less than about 0.2 percent, less than about 0.1 percent, less than about 0.09 percent, less than about 0.08 percent, less than about 0.07 percent, less than about 0.06 percent, less than about 0.05 percent, less than about 0.04 percent, less than about 0.03 percent, less than about 0.02 percent, less than about 0.01 percent, less than about 0.009 percent, less than about 0.008 percent, less than about 0.007 percent, less than about 0.006 percent, less than about 0.005 percent, less than about 0.004 percent, less than about 0.003 percent, less than about 0.002 percent, or less than about 0.001 percent of the emulsifier by weight of the diet.

In some embodiments, the nutritional supplement is present at about 0.001 to about 1 percent weight relative to the weight of the feed source. In some embodiments, the nutritional supplement is present at about 0.01 to about 0.5 percent weight relative to the weight of the feed source. In some embodiments, the nutritional supplement is present at about 0.025 to about 0.1 percent weight relative to the weight of the feed source.

In some embodiments, the nutritional supplement is present at about 0.001 to about 5 percent, about 0.005 to about 5 percent, about 0.01 to about 5 percent, about 0.02 to about 5 percent, about 0.03 to about 5 percent, about 0.04 to about 5 percent, about 0.05 to about 5 percent, about 0.06 to about 5 percent, about 0.07 to about 5 percent, about 0.08 to about 5 percent, about 0.09 to about 5 percent, about 0.1 to about 5 percent, about 0.2 to about 5 percent, about 0.3 to about 5 percent, about 0.4 to about 5 percent, about 0.5 to about 5 percent, about 0 6 to about 5 percent, about 0.7 to about 5 percent, about 0.8 to about 5 percent, about 0.9 to about 5 percent, about 1 to about 5 percent, about 1.1 to about 5 percent, about 1.2 to about 5 percent, about 1.3 to about 5 percent, about 1.4 to about 5 percent, about 1.5 to about 5 percent, about 1.6 to about 5 percent, about 1.7 to about 5 percent, about 1.8 to about 5 percent, about 1.9 to about 5 percent, about 2 to about 5 percent, about 2.1 to about 5 percent, about 2.2 to about 5 percent, about 2.3 to about 5 percent, about 2.4 to about 5 percent, about 2.5 to about 5 percent, about 2.7 to about 5 percent, about 2.8 to about 5 percent, about 2.9 to about 5 percent, about 3 to about 5 percent, about 3.1 to about 5 percent, about 3.2 to about 5 percent, about 3.3 to about 5 percent, about 3.4 to about 5 percent, about 3.5 to about 5 percent, about 3.6 to about 5 percent, about 3.7 to about 5 percent, about 3.8 to about 5 percent, about 3.9 to about 5 percent, about 4 to about 5 percent, about 4.1 to about 5 percent, about 4.2 to about 5 percent, about 4.3 to about 5 percent, about 4.4 to about 5 percent, about 4.5 to about 5 percent, about 4.6 to about 5 percent, about 4.7 to about 5 percent, about 4.8 to about 5 percent, or about 4.9 to about 5 percent weight relative to the weight of the feed source.

In some embodiments, the feed source is animal feed. In some embodiments, the animal feed comprises poultry feed, swine feed, aquatic animal feed, or ruminant feed. In some embodiments, the feed source is appropriate for human consumption. In some embodiments, the feed source further comprises water.

In some embodiments, the nutritional supplement is present in a ratio of the nutritional supplement to the feed source of about 0.1 kg of nutritional supplement per ton of the feed source to about 2 kg of the nutritional supplement per ton of the feed source. In some embodiments, the nutritional supplement is present in a ratio of the nutritional supplement to the feed source of about 0.2 kg of nutritional supplement per ton of the feed source to about 1.5 kg of the nutritional supplement per ton of the feed source. In some embodiments, the nutritional supplement is present in a ratio of the nutritional supplement to the feed source of about 0.5 kg nutritional supplement per ton of the feed source to about 1 kg of the nutritional supplement per ton of the feed source.

In some embodiments, the nutritional supplement is present in a ratio of the nutritional supplement to the feed source of about 0.001 kg of nutritional supplement per ton of the feed source to about 10 kg of nutritional supplement per ton of the feed source, about 0.005 kg of nutritional supplement per ton of the feed source to about 10 kg of nutritional supplement per ton of the feed source, about 0.01 kg of nutritional supplement per ton of the feed source to about 10 kg of nutritional supplement per ton of the feed source, about 0.02 kg of nutritional supplement per ton of the feed source to about 10 kg of nutritional supplement per ton of the feed source, about 0.03 kg of nutritional supplement per ton of the feed source to about 10 kg of nutritional supplement per ton of the feed source, about 0.04 kg of nutritional supplement per ton of the feed source to about 10 kg of nutritional supplement per ton of the feed source, about 0.05 kg of nutritional supplement per ton of the feed source to about 10 kg of nutritional supplement per ton of the feed source, about 0.06 kg of nutritional supplement per ton of the feed source to about 10 kg of nutritional supplement per ton of the feed source, about 0.07 kg of nutritional supplement per ton of the feed source to about 10 kg, about 0.08 kg to about 10 kg of nutritional supplement per ton of the feed source, about 0.09 kg of nutritional supplement per ton of the feed source to about 10 kg of nutritional supplement per ton of the feed source, about 0.1 kg of nutritional supplement per ton of the feed source to about 10 kg of nutritional supplement per ton of the feed source, about 0.2 kg of nutritional supplement per ton of the feed source to about 10 kg of nutritional supplement per ton of the feed source, about 0.3 kg of nutritional supplement per ton of the feed source to about 10 kg of nutritional supplement per ton of the feed source, about 0.4 kg of nutritional supplement per ton of the feed source to about 10 kg of nutritional supplement per ton of the feed source, about 0.5 kg of nutritional supplement per ton of the feed source to about 10 kg of nutritional supplement per ton of the feed source, about 0.6 kg of nutritional supplement per ton of the feed source to about 10 kg of nutritional supplement per ton of the feed source, about 0.7 kg of nutritional supplement per ton of the feed source to about 10 kg of nutritional supplement per ton of the feed source, about 0.8 kg of nutritional supplement per ton of the feed source to about 10 kg of nutritional supplement per ton of the feed source, about 0.9 kg of nutritional supplement per ton of the feed source to about 10 kg of nutritional supplement per ton of the feed source, about 1 kg of nutritional supplement per ton of the feed source to about 10 kg of nutritional supplement per ton of the feed source, about 1 kg of nutritional supplement per ton of the feed source to about 100 kg of nutritional supplement per ton of the feed source, about 1 kg of nutritional supplement per ton of the feed source to about 50 kg of nutritional supplement per ton of the feed source, about 5 kg of nutritional supplement per ton of the feed source to about 50 kg of nutritional supplement per ton of the feed source, about 10 kg of nutritional supplement per ton of the feed source to about 50 kg of nutritional supplement per ton of the feed source, about 15 kg of nutritional supplement per ton of the feed source to about 50 kg of nutritional supplement per ton of the feed source, about 20 kg of nutritional supplement per ton of the feed source to about 50 kg of nutritional supplement per ton of the feed source, about 25 kg of nutritional supplement per ton of the feed source to about 50 kg of nutritional supplement per ton of the feed source, about 30 kg of nutritional supplement per ton of the feed source to about 50 kg of nutritional supplement per ton of the feed source, about 35 kg of nutritional supplement per ton of the feed source to about 50 kg of nutritional supplement per ton of the feed source, about 40 kg of nutritional supplement per ton of the feed source to about 50 kg of nutritional supplement per ton of the feed source, about 45 kg of nutritional supplement per ton of the feed source to about 50 kg of nutritional supplement per ton of the feed source, about 10 kg of nutritional supplement per ton of the feed source to about 100 kg of nutritional supplement per ton of the feed source, about 20 kg of nutritional supplement per ton of the feed source to about 100 kg of nutritional supplement per ton of the feed source, about 30 kg of nutritional supplement per ton of the feed source to about 100 kg of nutritional supplement per ton of the feed source, about 40 kg of nutritional supplement per ton of the feed source to about 100 kg of nutritional supplement per ton of the feed source, about 60 kg of nutritional supplement per ton of the feed source to about 100 kg of nutritional supplement per ton of the feed source, about 70 kg of nutritional supplement per ton of the feed source to about 100 kg of nutritional supplement per ton of the feed source, about 80 kg of nutritional supplement per ton of the feed source to about 100 kg of nutritional supplement per ton of the feed source, or about 90 kg of nutritional supplement per ton of the feed source to about 100 kg of nutritional supplement per ton of the feed source.

In some embodiments, the feed source comprises 1 percent to 1,000 percent less calcium or phosphorous by weight of the feed source than the control feed source. In some embodiments, the feed source comprises 1 percent to 500 percent less calcium or phosphorous by weight of the control feed source. In some embodiments, the feed source comprises 1 percent to 200 percent less calcium or phosphorous by weight of the control feed source. In some embodiments, the feed source comprises 1 percent to 100 percent less calcium or phosphorous by weight of the feed source than the control feed source. In some embodiments, the feed source comprises 1 percent to 50 percent less calcium or phosphorous by weight of the feed source than the control feed source. In some embodiments, the feed source comprises 1 percent to 25 percent less calcium or phosphorous by weight of the feed source than the control feed source. In some embodiments, the feed source comprises 1 percent to 10 percent less calcium or phosphorous by weight of the feed source than the control feed source. In some embodiments, the feed source comprises 1 percent to 0.01 percent less calcium or phosphorous by weight of the feed source than the control feed source. In some embodiments, the feed source comprises 1 percent to 5 percent less calcium or phosphorous by weight of the control feed source. In some embodiments, the feed source comprises 1 percent less calcium or phosphorous by weight of the feed source than the control feed source. In some embodiments, the feed source comprises less calcium and phosphorous by weight of the control the feed source. In some embodiments, the feed source does not contain meat or bone meal or dicalcium phosphate or any other supplemental source of phosphorus.

As used herein, the term control feed source refers to a feed source comprising a nutritional profile which has been optimized to promote growth or health of an animal but lacks a calcium or phosphate absorption optimizer. The term calcium or phosphate absorption optimizer refers to compounds known or believed to enhance the absorption of calcium or phosphate by an animal. Examples of calcium or phosphate absorption optimizers include but are not limited to the emulsifier of the present invention, the enzyme phytase, and organic minerals (chelates) that improve the absorption of phosphate or calcium. Non-limiting examples of control feed sources include commercially available animal feeds lacking a compound of the present invention and feed sources designed by a nutritionist for optimal growth or health of an animal based on the expected rate of phosphorous and calcium absorption in that animal without enhancement.

### Methods of Enhancing Calcium and Phosphate Absorption in an Animal

Described herein are methods of increasing bioavailability of phosphorous, calcium, or both, in a subject, the method comprising feeding the animal a diet, a nutritional supplement, an emulsifier, an emulsifier solution, a feed, or any combination thereof as described herein. Described herein are methods of increasing bioavailability of phosphorous, calcium, or both, in a subject, the method comprising feeding the animal a diet as described herein. Described herein are methods of increasing bioavailability of phosphorous, calcium, or both, in a subject, the method comprising feeding the animal nutritional supplement as described herein.

In some embodiments, disclosed herein is a method of feeding an individual, the method comprising providing a composition to the individual, wherein the composition comprises: a carrier selected from: one or more sources of lime, one or more sources of silica, sodium chloride, one or more fibrous sources, or a combination thereof; and a salt of Formula (I).

The composition of the present disclosure represents only a tiny amount of the feed formulation of the animal feed, allowing the inclusion of other raw materials. In numerical terms, the composition may comprise about 0.1% of the feed formulation, against about 1.5% of phosphates and 5% of animal meal.

In some embodiments, the method comprises not supplementing the animal's diet with additional sources of calcium and phosphate. In some embodiments, the method comprises not including bone meal in the animal's diet.

In some embodiments, a method of feeding animals comprises providing the animal with a diet.

As used herein, the term diet refers to the sum of food provided to an animal or human for consumption. For the sake of clarity, in the case of domestic animals and livestock, diet refers to sum of food that was provided by a human and includes the amount of food a nutritionist calculates will be foraged by the animal from its environment (e.g., pen, pasture, field, etc.).

In some embodiments, a method for feeding an animal comprises providing to an animal a diet which comprises a feed source and a nutritional supplement.

In some embodiments, a method for feeding an animal comprises feeding the animal an emulsifier and a feed source wherein the feed source comprises less calcium or phosphorous than a control feed source without the emulsifier.

In some embodiments, described herein are methods of enhancing calcium and phosphate absorption in a subject comprising the administration of an effective amount of an emulsifier or nutritional supplement. In some embodiments, the method bypasses the regulation of calcium and phosphate absorption by calcitonin, parathormone, vitamin D3, or any combination thereof. In some embodiments, the enhanced phosphate absorption provides benefits including improving bone health, increasing energy levels, improving metabolic function, supporting growth and development in children, supporting fetal growth and maternal metabolism during gestation and lactation, supporting bone health, supporting longevity in the elderly, enhancement of performance and recovery in athletes, or any combination thereof.

In some embodiments, altering the at least one nutrition indicator comprises increasing or decreasing the at least one nutrition indicator (e.g., vitamin D, calcium, phosphorus, ionized calcium, etc.). In some embodiments, altering the at least one nutrition indicator comprises increasing the at least one nutrition indicator (e.g., vitamin D, calcium, phosphorus, ionized calcium, etc.). In some embodiments, altering the at least one nutrition indicator comprises decreasing the at least one nutrition indicator (e.g., vitamin D, calcium, phosphorus, ionized calcium, etc.). In some embodiments, altering vitamin D levels or vitamin D concentration is increasing the vitamin D levels or vitamin D concentration in the subject. In some embodiments, altering vitamin D levels or vitamin D concentration is decreasing the vitamin D levels or vitamin D concentration in the subject.

In some embodiments, administering an effective amount of an emulsifier or nutritional supplement to an animal provides a benefit to a nutritional indicator.

In some embodiments, administering an effective amount of an emulsifier or nutritional supplement to an animal provides a benefit to weight gain.

In some embodiments, administering an effective amount of an emulsifier or nutritional supplement to poultry provides a benefit to egg quality, for example shell strength.

In some embodiments, administering an effective amount of an emulsifier or nutritional supplement to poultry provides a benefit to egg weight.

In some embodiments, administering an effective amount of an emulsifier or nutritional supplement to an animal provides a benefit to weight gain, for example carcass yield, average carcass wight, and average live weight.

In some embodiments, administering an effective amount of an emulsifier or nutritional supplement to an animal provides a benefit to bone healing, for example fracture healing rate.

In some embodiments, administering an effective amount of an emulsifier or nutritional supplement to poultry provides a benefit to shell quality, for example shell strength.

In some embodiments, administering an effective amount of an emulsifier or nutritional supplement to an animal provides a benefit to bone radiopacity.

In some embodiments, administering an effective amount of an emulsifier or nutritional supplement to an animal provides a benefit to feed conversion.

In some embodiments, administering an effective amount of an emulsifier or nutritional supplement to an animal provides a benefit to milk production.

In some embodiments, a method for feeding an animal comprises the animal consuming a feed source comprising less calcium or phosphorous than a control feed source and the emulsifier solution and displaying the same or enhanced level of at least one nutrition indicator relative to the animal consuming the control feed source without the emulsifier solution.

In some embodiments, a nutritional indicator is weight gain, egg shell quality, carcass yield, average live weight, average carcass weight, bone fracture healing rate, blood serum calcium or phosphate levels, decreased levels of calcium or phosphate in excreta, bone radiopacity, egg production, egg quality, feed conversion rate, daily weight gain, final litter weight, meat quality score, average weight daily gain, feed efficiency, body condition score, ionized calcium levels, vitamin D levels, reproductive parameters, fertility, prolificity, ease of birth, reduction of problems associated with pregnancy, reduction of problems associated with delivery, reduction in issues with prolapses, reduction in issues with placenta retention, or any combination thereof.

In some embodiments, the animal is provided the diet yearly. In some embodiments, the animal is provided the diet monthly. In some embodiments, the animal is provided the diet weekly. In some embodiments, the animal is provided the diet daily. In some embodiments, the animal is provided the diet twice daily. In some embodiments, the animal is provided the diet three times a day. In some embodiments, the animal is provided the diet four times a day. In some embodiments, the animal is provided the diet continuously. In some embodiments, the animal is provided the diet as needed. In some embodiments, the animal is provided the diet once.

### Poultry

In some embodiments, the methods described herein increases the frequency of egg production, increases the egg quality, increases the growth of meat in weight in the poultry, increases the bone radiopacity in the poultry, increases bone strength in the poultry, or any combination thereof. In some embodiments, the increases in egg quality comprises increase in egg shell strength, egg shell thickness, or both.

In the case of egg production, as the emulsifier derived from ricinoleic acid of the present disclosure is transferred to the shell membrane, the proportion of eggs with shell problems is significantly reduced, which would make them unsaleable, maximizing productivity. It is usual to lose up to 7% of the eggs produced daily by shell problems. With the use of the current invention, this level is reduced below 2%, that is, increasing by up to 5% the amount of saleable eggs, with excellent cost-benefit ratio. In breeding birds, the proportion of incubatable eggs can also increase. The ricinoleic acid derivative disclosed herein is also able to reduce the problems of chickens and other laying birds in relation to poor bone calcification, frequent when the demand for calcium and phosphorus is not met throughout the life of the bird, reducing the mortality of the birds, and increasing their productive longevity.

In some embodiments, an emulsifier may be fed to poultry in an amount of about 0.0023% to about 0.0046% by weight of the total diet. In some embodiments the emulsifier is a compound of Formula (1).

In some embodiments, poultry may be fed a nutritional supplement comprising about 5% of a compound of Formula (I), about 15% of and an aqueous solution of water and sodium hydroxide (NaOH), about 35% diatomite (i.e., silica), and about 45% limestone (i.e., calcium) by weight of the nutritional supplement.

In some embodiments, poultry may be fed a diet comprising about 0.05% to about 0.1% of an emulsifier by weight of the feed source.

In some embodiments, poultry may be fed about 0.005 g to about 0.2 g of the nutritional supplement.

In some embodiments, methods described herein increases the production of milk in the ruminant, increases the growth of meat in weight in the ruminant, or any combination thereof. In some embodiments, methods described herein increases the growth of meat in weight in the ruminant.

In some embodiments, the nutritional supplement administered about 5 g to about 25 g per day. In some embodiments, the nutritional supplement administered about 10 g to about 20 g per day. In some embodiments, the nutritional supplement administered about 15 g per day.

In some embodiments, the diet is administered about 20 kg to about 60 kg per day. In some embodiments, the diet is administered about 25 kg to about 55 kg per day. In some embodiments, the diet is administered about 30 kg to about 50 kg per day.

In some embodiments, an emulsifier may be fed to ruminants in an amount of about 0.0035% by weight of the total diet. In some embodiments the emulsifier is a compound of Formula (1).

In some embodiments, ruminants may be fed a nutritional supplement comprising about 5% of a compound of Formula (I), about 15% of and an aqueous solution of water and sodium hydroxide (NaOH), about 30% diatomite (i.e., silica), and about 50% limestone (i.e., calcium) by weight of the nutritional supplement.

In some embodiments, the nutritional supplement is administered about 0.15 g to about 1.5 g per day.

In some embodiments, ruminants may be fed a diet comprising about 0.075% to about 0.1250% of an emulsifier by weight of the feed source.

In some embodiments, ruminants may be fed about 1.5 g to about 18.75 g of the nutritional supplement daily.

In some embodiments, methods described herein increases the volume of milk produced by the swine, improves the quality of milk produced by the swine, increases the growth of meat in weight in the swine, or any combination thereof.

In some embodiments, an emulsifier may be fed to swine in an amount of about 0.00115% to about 0.0056% by weight of the total diet. In some embodiments the emulsifier is a compound of Formula (1).

In some embodiments, swine may be fed a nutritional supplement comprising about 5% of a compound of Formula (I), about 15% of and an aqueous solution of water and sodium hydroxide (NaOH), about 30% diatomite (i.e., silica), and about 50% limestone (i.e., calcium) by weight of the nutritional supplement.

In some embodiments, swine may be fed a diet comprising about 0.0025% to about 0.1% of an emulsifier by weight of the feed source.

In some embodiments, the swine is administered about 0.075 g to about 4.0 kg of the diet per day. In some embodiments, swine may be fed about 0.075 g to about 12 g of the nutritional supplement daily.

In some embodiments, disclosed herein is a method of increasing bioavailability of phosphorous, calcium, or both, comprising administering a compound of Formula (I) to a subject.

In some embodiments, disclosed herein is a method of enhancing calcium and phosphate absorption in a subject, comprising the administration of a composition comprising a salt of Formula (I).

In some embodiments, a method of increasing absorption of in a subject comprises administering a nutritional supplement of the present disclosure to an animal.

In some embodiments, the composition disclosed herein increases calcium and phosphate absorption by at least about 70% to about 99.9%. In some embodiments, the composition disclosed herein increases calcium and phosphate absorption by at least about 70% to about 75%, about 70% to about 80%, about 70% to about 85%, about 70) % to about 90%, about 70% to about 95%, about 70% to about 98%, about 70% to about 99%, about 70) % to about 99.9%, about 75% to about 80%, about 75% to about 85%, about 75% to about 90%, about 75% to about 95%, about 75% to about 98%, about 75% to about 99%, about 75% to about 99.9%, about 80% to about 85%, about 80% to about 90%, about 80% to about 95%, about 80% to about 98%, about 80% to about 99%, about 80% to about 99.9%, about 85% to about 90%, about 85% to about 95%, about 85% to about 98%, about 85% to about 99%, about 85% to about 99.9%, about 90% to about 95%, about 90% to about 98%, about 90% to about 99%, about 90% to about 99.9%, about 95% to about 98%, about 95% to about 99%, about 95% to about 99.9%, about 98% to about 99%, about 98% to about 99.9%, or about 99% to about 99.9%. In some embodiments, the composition disclosed herein increases calcium and phosphate absorption by at least about 70%, about 75%, about 80%, about 85%, about 90%, about 95%, about 98%, about 99%, or about 99.9%. In some embodiments, the composition disclosed herein increases calcium and phosphate absorption by at least about 70%, about 75%, about 80%, about 85%, about 90%, about 95%, about 98%, or about 99%. In some embodiments, the composition disclosed herein increases calcium and phosphate absorption by at least at most about 75%, about 80%, about 85%, about 90%, about 95%, about 98%, about 99%, or about 99.9%.

The present disclosure also contemplates the method of production of a composition to increase the absorption of calcium and phosphorus in the digestive tract of farm animals comprising the steps of: saponifying a fatty acid with a strong base, at a high temperature; and mixing the fatty acid obtained in step (A) with fatty acid salts, of high molecular weight.

The present disclosure also contemplates the use of a composition disclosed herein for the production of a ration to increase the absorption of calcium and phosphorus in the digestive tract of farm animals.

Without wishing to be bound by theory, it is believed that the method works by bypassing the regulation of calcium and phosphate absorption by calcitonin, parathormone, and vitamin D3.

In some embodiments the subject is a farm animal, a pet, or a human.

In some embodiments, disclosed herein is use of a compound of Formula (I) for the manufacture of a composition for enhancing phosphate absorption in a subject.

In some embodiments, disclosed herein is use of a ricinoleic acid salt for the manufacture of a composition for enhancing phosphate absorption in the body of a human or an animal.

The present disclosure provides a composition and the use of this to maximize the absorption of calcium and phosphorus in the digestive tract of farm animals. In addition, the use of an emulsifier derived from ricinoleic acid is provided for, as well as a formulation of the emulsifier and its manufacturing method. In this way, the present disclosure allows the complete exclusion of supplementary phosphorus sources from the diets of farm animals, and the significant reduction of calcium sources, providing an alternative to replace meat and bone meal in feed. In some embodiments, a nutritional matrix of up to 200% total calcium, up to 200% digestible calcium, up to 200% total phosphorus, up to 200% digestible or available phosphorus, and/or up to 48.000 kcal of metabolizable energy.

In some embodiments, the nutritional supplement is combined with animal feed and fed to at least one animal. In some embodiments, providing an animal with animal feed comprising a nutritional supplement of the present invention enhances calcium and phosphorus absorption in the animal. In some embodiments, animal feeds comprising a nutritional supplement of the present invention may contain less calcium and phosphates than animal feeds lacking the nutritional supplement. In some embodiments, providing animal feeds comprising the nutritional supplement and less calcium and phosphate than an equivalent animal feed lacking the nutritional supplement to an animal will result in the same or enhanced calcium and phosphate absorption compared to providing the equivalent animal feed lacking the nutritional supplement.

In some embodiments, swine may be fed a lower amount of a nutritional supplement as described herein during the finishing stage than they were fed during the growth stage.

In some embodiments, the invention is fed to humans for nutritional benefits.

In some embodiments, methods described herein increases phosphorous concentration, increases calcium concentration, decreases ionized calcium concentration, alters vitamin D concentration in blood serum, or any combination thereof.

In some embodiments, the nutritional supplement is administered about 0.1 g to about 3.5 g per day. In some embodiments, the nutritional supplement is administered about 0.5 g to about 2.5 g per day. In some embodiments, the nutritional supplement is administered about 1.5 g per day.

In some embodiments, the nutritional supplement is administered at least once daily. In some embodiments, the nutritional supplement is administered once to every 3 days.

In some embodiments, the phosphorus concentration in blood serum increases by about 0.1 mg/dL to about 2 mg/dL. In some embodiments, the phosphorus concentration in blood serum increases by about 0.3 mg/dL to about 1 mg/dL. In some embodiments, the phosphorus concentration in blood serum increases by about 1% to about 50%. In some embodiments, the phosphorus concentration in blood serum increases by about 10% to about 35%.

In some embodiments, the calcium concentration in blood serum increases by about 0.1 mg/dl to about 5 mg/dL. In some embodiments, the calcium concentration in blood serum increases by about 0.2 mg/dL to about 0.3 mg/dL. In some embodiments, the calcium concentration in blood serum increases by about 0.1% to about 5%. In some embodiments, the calcium concentration in blood serum increases by about 2% to about 3%.

In some embodiments, the ionized calcium concentration in blood serum decreases by about 0.005 mmol/L to about 0.1 mmol/L. In some embodiments, the ionized calcium concentration in blood serum decreases by about 0.01 mmol/L. In some embodiments, the ionized calcium concentration in blood serum increases by about 0.005% to about 0.01%. In some embodiments, the ionized calcium concentration in blood serum increases by about 0.007%.

In some embodiments, the vitamin D concentration in blood serum decreases by about 10 ng/mL to about 35 ng/mL. In some embodiments, the vitamin D concentration in blood serum decreases by about 22.7 ng/ml. In some embodiments, the vitamin D concentration in blood serum decreases by about 20% to about 50%. In some embodiments, the vitamin D concentration in blood serum decreases by about 34%.

In some embodiments, the vitamin D concentration in blood serum is altered by about 10 ng/ml to about 35 ng/ml. In some embodiments, the vitamin D concentration in blood serum is altered by about 22.7 ng/mL. In some embodiments, the vitamin D concentration in blood serum is altered by about 20% to about 50%. In some embodiments, the vitamin D concentration in blood serum is altered by about 34%.

In some embodiments, bone radiopacity is measured by radiographic imaging.

### Certain Terminology

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range

Whenever the term “at least.” “greater than.” or “greater than or equal to” precedes the first numerical value in a series of two or more numerical values, the term “at least.” “greater than” or “greater than or equal to” applies to each of the numerical values in that series of numerical values. For example, greater than or equal to 1.2, or 3 is equivalent to greater than or equal to 1, greater than or equal to 2, or greater than or equal to 3.

Whenever the term “no more than.” “less than.” or “less than or equal to” precedes the first numerical value in a series of two or more numerical values, the term “no more than.” “less than.” or “less than or equal to” applies to each of the numerical values in that series of numerical values. For example, less than or equal to 3, 2, or 1 is equivalent to less than or equal to 3, less than or equal to 2, or less than or equal to 1.

“Alkyl” refers to a straight-chain, or branched-chain saturated hydrocarbon monoradical having from one to about ten carbon atoms, more preferably one to seven carbon atoms. Examples include, but are not limited to methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, n-butyl, isobutyl, sec-butyl, t-butyl, n-pentyl, isopentyl, neopentyl, tert-amyl and hexyl, and longer alkyl groups, such as heptyl, octyl and the like. Whenever it appears herein, a numerical range such as “C₁-C₇ alkyl” or “C₁₋₇alkyl”, means that the alkyl group may consist of 1 carbon atom, 2 carbon atoms, 3 carbon atoms, 4 carbon atoms, 5 carbon atoms, 6 carbon atoms, or 7 carbon atoms, although the present definition also covers the occurrence of the term “alkyl” where no numerical range is designated. In some embodiments, the alkyl is a C₁₋₆alkyl. In some embodiments, the alkyl is a C₁₋₅alkyl. In some embodiments, the alkyl is a C₁₋₄alkyl. In some embodiments, the alkyl is a C₁₋₃alkyl.

The terms “subject.” “individual.” or “patient” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. In some embodiments, the subject is an animal. In some embodiments, the animal is a ruminant, a poultry, a swine, an aquatic animal, or a human. In some embodiments, the animal is a ruminant. The subject or mammal can be a human. The subject may be diagnosed or suspected of being at high risk for a disease. In some cases, the subject is not necessarily diagnosed or suspected of being at high risk for the disease. The term “subject” or “patient” encompasses mammals. Examples of mammals include, but are not limited to, humans. In one embodiment, the mammal is a human. In some embodiments, the ruminant is a steer, a beef producing ruminant, or a milk producing ruminant. In some embodiments, the animal is poultry. In some embodiments, the poultry is a broiler poultry, a breeding poultry, or a laying hen. In some embodiments, the animal is swine. In some embodiments, the swine is a sow or a piglet. In some embodiments, the subject is a farm animal, a pet, or a human.

As used herein, the term “about” a number refers to that number plus or minus 10% of that number. The term “about” a range refers to that range minus 10% of its lowest value and plus 10% of its greatest value.

### EXAMPLES

The following examples are intended to illustrate but not limit the disclosed embodiments.

### Example 1: Weight Gain in Broilers

In order to assess the effect of the use of the emulsifier on calcium and phosphorus absorption in growing animals, a study comparing weight gain in hens up to 21 days of age was carried out. The study was conducted in integration in the state of Santa Catarina, wherein animals were split into batches to receive feeds with the emulsifier and then have their weight gains compared to similar batches, with the same age and weight, that served as controls and did not receive the emulsifier.

More specifically, the animals were split into 2 groups, wherein group 1 received a diet comprising a feed source and a nutritional supplement of the present disclosure and group 2 received conventional (control) feed source without the nutritional supplement. The test results are illustrated in Table 1 below. A month of use of the nutritional supplement improved the weight of the hens tested, demonstrating nutritional improvement.

TABLE 1
Weight gain comparison in hens that received
the emulsifier up to 21 days of age.

| | HOUSED | WEIGHT IN GRAMS PER DAY | | | | |
|---|---|---|---|---|---|---|
| | HENS | 1 | 7 | 14 | 21 | 28 |
| Group 1 - with | 37,000 | 40 | 160 | 460 | 1037 | 1754 |
| nutritional | | | | | | |
| supliment | | | | | | |
| Group 2 - control | 37,000 | 40 | 155 | 450 | 1034 | 1617 |

### Example 2: Comparison Between Feed Formulations for Hens

The feed source used in the study about weight gain, with and without the nutritional supplement of the present invention, and the costs thereof are illustrated in Tables 2 to 5 below. Tables 2 and 3 depict the feed source with and without the nutritional supplement and Tables 4 and 5 depict the nutrient levels of feed sources with and without the nutritional supplement. The results of the experiment show improved nutritional outcomes with the ricinoleic acid formulations. As can be observed from the Tables 2-5, the product containing the nutritional supplement is cheaper than that without the nutritional supplement. Table comparison shows that the feed formulations with the nutritional supplement comprising ricinoleic acid, besides being cheaper, thus reducing production costs, increase calcium and phosphorus content, from 1.045% to 1.185% and from 0.550% to 0.624%, respectively.

TABLE 2
Feed formulation for hens without the nutritional supplement

| Ingredient | Cost per kg | Amount (kg) |
|---|---|---|
| Corn | 1,500 | 564,327 |
| Soybean meal | 2,000 | 287,468 |
| Offal meal | 3,900 | 50,000 |
| Meat and Bone Meal | 2,320 | 40,000 |
| Poultry Fat | 6,000 | 18,000 |
| Degummed soybean oil | 6,740 | 14,094 |
| Liquid methionine | 12,150 | 4,622 |
| Lysine 60% | 7,140 | 3,705 |
| Sodium bicarbonate | 2,590 | 3,700 |
| Starter Premix | 18,810 | 2,900 |
| Phosphate | 4,270 | 2,779 |
| Limestone | 0,300 | 2,549 |
| Granulated Salt | 0,610 | 1,582 |
| L-Threonine | 9,680 | 1,530 |
| Calibrin | 10,230 | 1,000 |
| Essential oil | 18,750 | 0,500 |
| Anticoccidian Premix feed | 53,000 | 0,500 |
| L-Valine | 20,220 | 0,494 |
| Organic selenium | 27,500 | 0,150 |
| Precizyon X50 | 1,000 | 0,100 |
| TOTAL | 2,148 | 1,000,000 |

TABLE 3
Pre-starter feed formulation for hens
with the nutritional supplement

| Ingredient | Cost per kg | Amount (kg) |
|---|---|---|
| Corn | 1,500 | 564,327 |
| Soybean meal | 2,000 | 287,468 |
| Offal meal | 6,220 | 50,000 |
| Poultry Fat | 6,000 | 18,000 |
| Degummed soybean oil | 6,740 | 14,094 |
| Limestone | 0,300 | 9,010 |
| Liquid methionine | 12,150 | 4,622 |
| Sodium bicarbonate | 2,590 | 3,700 |
| Lysine 60% | 7,140 | 3,491 |
| Starter Premix | 18,810 | 2,899 |
| Granulated salt | 0,610 | 2,041 |
| L-Threonine | 9,680 | 1,441 |
| Calibrin | 10,230 | 1,000 |
| Emulsifying oil | 33,000 | 1,000 |
| Essential oil | 18,750 | 0,500 |
| Premix | 53,000 | 0,500 |
| anticoccidian feed | | |
| L-Valine | 20,220 | 0,411 |
| Organic selenium | 27,500 | 0,150 |
| Precizyon X50 | 1,000 | 0,100 |
| TOTAL | 2,135 | 1,000,000 |

TABLE 4
Nutrient levels in formulations without the
addition of the nutritional supplement

| Nutrient | Content | | | Intake |
|---|---|---|---|---|
| Moisture | 10.620% | | MIN | — |
| Dry matter | 88.403% | | MIN | — |
| Metabolic energy | 3,149.999 | | MAX | 3,151,000 |
| | kcal/kg | | MIN | 3,149,000 |
| Enzyme energy | 50,000 | kcal | MIN | — |
| Crude protein | 23.688% | | — | — |
| Enzymatic protein | 0.060% | | — | — |
| Ether extract | 6.912% | | — | — |
| Crude fiber | 2.340% | | — | — |
| Calcium | 1.045% | | — | — |
| Ca:Pd | 1.900 | | MIN | 1,900 |
| Available phosphorus | 0.550% | | MIN | 0,550 |
| Sodium | 0.220% | | MIN | 0,220 |
| Chlorine | 0.209% | | — | — |
| Potassium | 0.755% | | MIN | — |
| Electrolyte balance | 230,002 | mEq/kg | MIN | 230,000 |

| | | | |
|---|---|---|---|
| Digestible lysine | 1.300% | MIN | 1,300 |
| Digestible methionine | 0.717% | — | — |
| Digestible methionine + cysteine | 0.994% | — | — |
| Sulph:Lys | 0.765% | MIN | 0,765 |
| Digestible tryptophan | 0.231% | — | — |
| Trypt:Lys | 0.178 | — | — |
| Digestible threonine | 0.871% | — | — |
| Threo:Lys | 0.670 | MIN | 0,670 |
| Digestible arginine | 1.365% | — | — |
| Arg:Lys | 1.050 | MIN | 1,050 |
| Digestible leucine | 1.647% | — | — |

TABLE 5
Nutrient levels in formulations with the addition of the nutritional supplement

| Nutrient•¤ | Content•¤ | •¤ | Intake¤ |
|---|---|---|---|
| Moisture•¤ | 10.721%•¤ | —•¤ | —•¤ |
| Dry•matter•¤ | 88.212%•¤ | —•¤ | —•¤ |
| Metabolic•energy•¤ | 3,150,004•kcal/kg•¤ | MAX•¤ | 3,151,000•¤ |
| | | MIN•¤ | 3,149,000•¤ |
| Enzyme•energy••¤ | 50,000•kcal•¤ | MIN•¤ | —•¤ |
| Crude•protein•¤ | 23.446%•¤ | —•¤ | —•¤ |
| Enzymatic•protein•¤ | 0.060%•¤ | —•¤ | —•¤ |
| Ether•extract¤ | 6.426%¤ | —¤ | —¤ |
| Crude•fiber•¤ | 2.423%•¤ | —•¤ | —•¤ |
| Calcium¤ | 1.185%•¤ | —•¤ | —•¤ |
| Ca:P••¤ | 1,900•¤ | MIN•¤ | 1,900•¤ |
| Available•phosphorus••¤ | 0.624%•¤ | MIN•¤ | 0,550•¤ |
| Sodium•¤ | 0.220%•¤ | MIN•¤ | 0,220•¤ |
| Chlorine•¤ | 0.225%•¤ | —•¤ | —•¤ |
| Potassium•¤ | 0.773%•¤ | MIN•¤ | —•¤ |
| Electrolyte•balance•¤ | 230,001•mEq/kg•¤ | MIN•¤ | 230,000•¤ |
| Digestible•lysine•¤ | 1.300%•¤ | MIN•¤ | 1,300•¤ |
| Digestible•methionine••¤ | 0.710%•¤ | —•¤ | —•¤ |
| Digestible•methionine + cysteine•¤ | 0.995%•¤ | —•¤ | —•¤ |
| Sulph:Lys•¤ | 0.765%•¤ | MIN•¤ | 0,765•¤ |
| Digestible•tryptophan¤ | 0.238%•¤ | —•¤ | —•¤ |
| Trypt:Lys•¤ | 0,183•¤ | —•¤ | —•¤ |
| Digestible•threonine•¤ | 0.871%•¤ | —•¤ | —•¤ |
| Threo:Lys•¤ | 0,670•¤ | MIN•¤ | 0,670•¤ |
| Digestible•arginine•¤ | 1.365%•¤ | —•¤ | —•¤ |
| Arg:Lys•¤ | 1,050•¤ | MIN•¤ | 1,050•¤ |
| Digestible•leucine¤ | 1.665%¤ | —¤ | —¤ |

### Example 3: Assessment of Shell Quality in Laying Hen Farms

In order to assess the effect of the use of the nutritional supplement on the calcium and phosphorus absorption in laying hens, several studies on laying hens from different farms were carried out. The studies comprised the analysis of animals before and after the feed with the formulation containing the nutritional supplement comprising ingredients shown in Table 3.

More specifically, an assessment of the shell quality in laying hens was conducted by collecting the eggs before and after feeding the animals with the formulation containing the nutritional supplement. Hens from farms in the states of Espírito Santo (350,000 hens), São Paulo (2,000,000 hens), Paraná (1,100,000 hens), and Minas Gerais (850,00 hens) were fed with a pair of feed formulas, one without and another one with the nutritional supplement of the present invention.

Laid eggs were collected after feeding the hens with regular feed and later with the feed containing the emulsifier of the present invention. Data obtained from the analysis of the eggs from the farms in Espírito Santo, São Paulo, Paraná, and Minas Gerais are included in Tables 6 to 9 below, the beneficial effects on the shells being emphasized thereof, among them the reduction in cracks in chicken eggs. Data presented in Table 6 shows that the use of the nutritional supplement in poultry feed produces an increase in egg weight, a 2% improvement in crack occurrences as well as an improvement in other shell defects. The number of failed eggs dropped to zero and shell porosity was reduced.

Data presented in Table 6 shows that the use of the nutritional supplement in poultry feed produces an increase in egg weight, a 2% improvement in crack occurrences as well as an improvement in other shell defects. The number of failed eggs dropped to zero and shell porosity was reduced. It can be observed in Table 7 that there was an increase in egg weight in all assessed farms in the state of São Paulo and a decrease in crack occurrences. Other defects such as deformations, thin shells, and failed eggs also had a significant reduction. Table 8 shows data from eggs collected before and after the use of the nutritional supplement in the feed formulation on a farm in the state of Paraná. Data comparison, as expected, showed a reduction in crack occurrences, deformations, porosity, and thin shells Data shown in Table 9 refer to the study carried out on a farm in the state of Minas Gerais, wherein, as in the other farms, an increase in egg weight, a 2% improvement in crack occurrences, and an improvement in other shell defects were observed. The number of failed eggs, porosity, and shell deformation were reduced.

TABLE 6
Eggshell quality report - Farm in Espírito Santo
FLOCK: 350,000 HENS

| | | AGE/ | PROD. | REAL | | | | THIN | | |
|---|---|---|---|---|---|---|---|---|---|---|
| FARMS | LINEAGE | WEEKS | 01/22 | WEIGHT | CRACK | DEFORM. | FAILED | SHELL | DIRTY | POROUS |
| 1A | HISEX | 65 | 1.82 | 60.7 | 1 | 0 | 0 | 0 | 0 | 0 |
| | WHITE | | | | | | | | | |
| 1B | HISEX | 65 | 2.1 | 62.6 | 2 | 0 | 0 | 0 | 0 | 0 |
| | BROWN | | | | | | | | | |
| 3 | BOVANS | 81 | −0.52 | 61 | 1 | 2 | 0 | 1 | 0 | 1 |
| | WHITE | | | | | | | | | |
| 5 | ISA | 77 | −1.17 | 60.9 | 2 | 0 | 1 | 1 | 0 | 2 |
| | BROWN | | | | | | | | | |
| AVERAGE | | 72 | 0.6 | 61.3 | 2.5 | 0.8 | 0.4 | 0.4 | 0.0 | 1.3 |

TECHNICAL VISIT 8 WEEKS LATER

| | | | | | | | | | | |
|---|---|---|---|---|---|---|---|---|---|---|
| 1A | HISEX | 73 | 2.33 | 61 | 0 | 0 | 0 | 0 | 0 | 0 |
| | WHITE | | | | | | | | | |
| 1B | HISEX | 73 | 2.53 | 62.5 | 0 | 0 | 0 | 0 | 0 | 0 |
| | BROWN | | | | | | | | | |
| 3 | BOVANS | 89 | −0.22 | 61.5 | 0 | 2 | 0 | 1 | 0 | 0 |
| | WHITE | | | | | | | | | |
| 5 | ISA | 85 | −1.56 | 61.7 | 1 | 0 | 0 | 0 | 0 | 1 |
| | BROWN | | | | | | | | | |
| AVERAGE | | 80 | 0.8 | 61.7 | 0.4 | 0.8 | 0.0 | 0.4 | 0.0 | 0.4 |

| | | | | | | | | |
|---|---|---|---|---|---|---|---|---|
| DIFFERENCE | 0.2 | 0.4 | 2.1 | 0.00 | 0.4 | 0.0 | 0 | 0.8 |

TABLE 7
Eggshell quality report - Farms in São Paulo
FLOCK: 2,000,000 HENS

| | | | AGE/ | PROD. | STD | DIFF. | REAL | STD | DIFF. |
|---|---|---|---|---|---|---|---|---|---|
| | FARMS | LINEAGE | WEEKS | 11/21 | % | % | WEIGHT | % | % |
| MONTEIRO | 517B-R07 | DEKALB | 61 | 87.75 | 87.4 | 0.35 | 57.6 | 64 | −6 |
| FARM | | WHITE | | | | | | | |
| | 521D-R05 | LOHMANN | 48 | 96.59 | 89.3 | 7.29 | 55.5 | 59.2 | −4 |
| | | WHITE | | | | | | | |
| | 582D-R04 | HY LINE | 27 | 83.37 | 96 | −12.6 | 52.1 | 59 | −7 |
| | | W80 | | | | | | | |
| | 511B-R01 | BOVANS | 74 | 88.11 | 83.8 | 4.31 | 61.1 | 64.8 | −4 |
| | AVERAGE | | 52 | 89.0 | 89.1 | −0.17 | 56.6 | 61.8 | −5 |

TECHNICAL VISIT 9 WEEKS LATER

| MONTEIRO | 517B-R07 | DEKALB | 70 | 80.09 | 85.2 | 2.2 | 58.8 | 65 | −6 |
|---|---|---|---|---|---|---|---|---|---|
| FARM | | WHITE | | | | | | | |
| | 521D-R05 | LOHMANN | 57 | 94.42 | 93.7 | 0.72 | 59.3 | 63.5 | −4 |
| | | WHITE | | | | | | | |
| | 582D-R04 | HY LINE | 36 | 89.15 | 96 | −3.5 | 54.1 | 61 | −7 |
| | | W80 | | | | | | | |
| | 511B-R01 | BOVANS | 83 | 87.75 | 81.6 | 6.15 | 62.8 | 65.5 | −3 |
| | AVERAGE | | 61 | 87.9 | 89.1 | 1.1 | 58.8 | 63.75 | −5 |
| DIFFERENCE | | | | | | 1.31 | 2.2 | | 0 |
| [symbol] | 524B-R19 | DEKALB | 45 | 83. [symbol] 2 | 93 | −9.78 | 61 | [symbol] 2 | −1 |
| FARM | | WHITE | | | | | | | |
| | 510B-R13 | EMPTY | 0 | 0 | 0 | 0 | 0 | 0 | 0 |
| | 528B-R05 | BOVANS | 38 | 92.31 | 95.5 | −3.19 | 56.8 | 63.1 | −4 |
| | 519B-R07 | H&N | 58 | 81 | 93.5 | −12.9 | 62.3 | 63.3 | −1 |
| | | WHITE | | | | | | | |
| | AVERAGE | | 47 | 85.51 | 94 | −8.49 | 60.0 | 62.153 | −2 |

TECHNICAL VISIT 9 WEEKS LATER

| [symbol] | 524B-R19 | DEKALB | 55 | 94.73 | 91.6 | [symbol] .13 | 61.6 | 63 | −1 |
|---|---|---|---|---|---|---|---|---|---|
| FARM | | WHITE | | | | | | | |
| | 510B-R13 | EMPTY | 0 | 0 | 0 | 0 | 0 | 0 | 0 |
| | 528B-R05 | BOVANS | 47 | 82.62 | 93.6 | −11 | 61.6 | 61.8 | −0.2 |
| | 519B-R07 | H&N | 67 | 86.55 | 90.6 | −4.05 | 63.5 | 54 | −0.5 |
| | | WHITE | | | | | | | |
| | AVERAGE | | 56 | 88.0 | 91.9333 | −3.97 | 62.2 | 62.9 | −1 |
| DIFFERENCE | | | | | | 4.52 | 2.2 | | 1 |
| TREVO | R05 | VAZIO | 0 | 0 | 0 | 0 | 0 | 0 | 0 |
| FARM | R09 | BOVANS | 45 | 96.41 | 88.7 | 7.71 | 62.1 | 63.3 | −1 |
| | R12 | BOVANS | 60 | 98.2 | 93.6 | 4.6 | 61.5 | 61.8 | −0.3 |
| | AVERAGE | | 53 | 97.31 | 91.2 | 6.16 | 61.8 | 62.6 | −0.8 |

TECHNICAL VISIT 9 WEEKS LATER

| | | | | | | | | | |
|---|---|---|---|---|---|---|---|---|---|
| TREVO | R05 | EMPTY | 0 | 0 | 0 | 0 | 0 | 0 | 0 |
| FARM | R09 | BOVANS | 54 | 96.4 | 91.9 | 4.52 | 62 | 63 | −1 |
| | R12 | BOVANS | 69 | 90.4 | 86.8 | 3.6 | 62.8 | 62.4 | 0.4 |
| | AVERAGE | | 61.5 | 93.4 | 89.4 | 4.1 | 62.4 | 62.7 | −0.3 |

| | | | |
|---|---|---|---|
| DIFFERENCE | −2.10 | 0.6 | 0.50 |

| | | | | | | THIN | | |
|---|---|---|---|---|---|---|---|---|
| | FARMS | LINEAGE | CRACK | DEFORM. | FAILED | SHELL | DIRTY | POROUS |
| MONTEIRO | 517B-R07 | DEKALB | 2 | 4 | 1 | 1 | 0 | 0 |
| FARM | | WHITE | | | | | | |
| | 521D-R05 | LOHMANN | 0 | 1 | 0 | 0 | 4 | 0 |
| | | WHITE | | | | | | |
| | 582D-R04 | HY LINE | 0 | 1 | 0 | 0 | 3 | 0 |
| | | W80 | | | | | | |
| | 511B-R01 | BOVANS | 2 | 5 | 1 | 1 | 1 | 1 |
| | AVERAGE | | 1.7 | 4.6 | 0.8 | 0.5 | [symbol] . [symbol] | 0.4 |

TECHNICAL VISIT 9 WEEKS LATER

| MONTEIRO | 517B-R07 | DEKALB | 0 | 2 | 0 | 0 | 1 | 0 |
|---|---|---|---|---|---|---|---|---|
| FARM | | WHITE | | | | | | |
| | 521D-R05 | LOHMANN | 0 | 1 | 0 | 0 | 4 | 0 |
| | | WHITE | | | | | | |
| | 582D-R04 | HY LINE | 0 | 0 | 0 | 0 | 3 | 0 |
| | | W80 | | | | | | |
| | 511B-R01 | BOVANS | 1 | 3 | 0 | 0 | 0 | 1 |
| | AVERAGE | | 0.4 | 2.5 | 0 | 0 | 3.3 | 0.4 |
| DIFFERENCE | | | 1.3 | 2.1 | 0.8 | 0.8 | 0.0 | 0.0 |
| [symbol] | 524B-R19 | DEKALB | 0 | 3 | 4 | 0 | 0 | 0 |
| FARM | | WHITE | | | | | | |
| | 510B-R13 | EMPTY | 0 | 0 | 0 | 0 | 0 | 0 |
| | 528B-R05 | BOVANS | 0 | 0 | 0 | 0 | 0 | 0 |
| | 519B-R07 | H&N | 2 | 3 | 1 | 0 | 2 | 0 |
| | | WHITE | | | | | | |
| | AVERAGE | | 1.13 | 3.53 | 2.78 | 0 | 1.11 | 0 |

TECHNICAL VISIT 9 WEEKS LATER

| [symbol] | 524B-R19 | DEKALB | 0 | 0 | 0 | 0 | 2 | 0 |
|---|---|---|---|---|---|---|---|---|
| FARM | | WHITE | | | | | | |
| | 510B-R13 | EMPTY | 0 | 0 | 0 | 0 | 0 | 0 |
| | 528B-R05 | BOVANS | 0 | 0 | 0 | 0 | 0 | 0 |
| | 519B-R07 | H&N | 0 | 0 | 0 | 0 | 0 | 0 |
| | | WHITE | | | | | | |
| | AVERAGE | | 0 | 0 | 0 | 0 | 1.11 | 0 |
| DIFFERENCE | | | 0.56 | 3.33 | 2.78 | 0 | 0 | 0 |
| TREVO | R05 | VAZIO | 0 | 0 | 0 | 0 | 0 | 0 |
| FARM | R09 | BOVANS | 1 | 2 | 0 | 1 | 1 | 0 |
| | R12 | BOVANS | 2 | 3 | 0 | 0 | 0 | 0 |
| | AVERAGE | | 2.50 | 4.17 | 0.00 | 0.8 | 0.8 | 0.00 |

TECHNICAL VISIT 9 WEEKS LATER

| | | | | | | | | |
|---|---|---|---|---|---|---|---|---|
| TREVO | R05 | EMPTY | 0 | 0 | 0 | 0 | 0 | 0 |
| FARM | R09 | BOVANS | 0 | 0 | 0 | 0 | 0 | 0 |
| | R12 | BOVANS | 0 | 0 | 0 | 0 | 0 | 0 |
| | AVERAGE | | 0 | 0 | 0 | 0 | 0 | 0 |

| | | | | | | |
|---|---|---|---|---|---|---|
| DIFFERENCE | 2.50 | 4.17 | 0 | 0.8 | 0.8 | 0 |

[symbol]

indicates data missing or illegible when filed

TABLE 8
Eggshell quality report - Farm in Paraná

| | | | | | | THIN | |
|---|---|---|---|---|---|---|---|
| FARMS | LINEAGE | AGE | WEIGHT | CRACK | DEFORMED | SHELL | POROUS |
| FARM 1 | LOHMANN | 90 | 63.5 | 4 | 2 | 3 | 2 |
| | WHITE | | | | | | |
| FARM 2 | BOVANS WHITE | 55 | 59.3 | 1 | 0 | 0 | 0 |
| FARM 3 | ISA BROWN | 80 | 61 | 3 | 0 | 0 | 0 |
| FARM 4 | BOVANS WHITE | 48 | 56.5 | 1 | 3 | 0 | 1 |
| FARM 5 W | BOVANS WHITE | 19 | 45 | 0 | 0 | 0 | 0 |
| FARM 5 E | ISA BROWN | 19 | 48.3 | 0 | 2 | 0 | 0 |
| FARM 5 B | ISA BROWN | 19 | 47.5 | 0 | 0 | 0 | 0 |
| FARM 6 | HISEX BROWN | 27 | 56 | 1 | 0 | 0 | 0 |
| FARM 7 | ISA BROWN | 56 | 60 | 2 | 0 | 0 | 0 |
| FARM 8 | LOHMANN | 66 | 63.5 | 3 | 3 | 1 | 1 |
| | WHITE | | | | | | |
| FARM 9 | EMPTY | 0 | 0 | 0 | 0 | 0 | 0 |
| FARM 10 | LOHMANN | 22 | 61.5 | 0 | 2 | 1 | 0 |
| | WHITE | | | | | | |
| FARM 11 | HISEX WHITE | 54 | 59.3 | 1 | 0 | 1 | 0 |
| FARM 12 | BOVANS WHITE | 64 | 61 | 3 | 1 | 3 | 2 |
| AVERAGE | — | — | 61.9 | 2.3 | 3.25 | 1.07 | 0.71 |

TECHNICAL VISIT 36 WEEKS LATER

| | | | | | | | |
|---|---|---|---|---|---|---|---|
| FARM 1 | LOHMANN | 126 | 64.3 | 2 | 3 | 1 | 0 |
| | WHITE | | | | | | |

NOTE:
CAMPOHAS 2.1% OF CRACKS BUT ARRIVES AT THE EGG ROOM WITH6.5%

TABLE 9
Eggshell quality report - Farm in Minas Gerais

| | | AGE/ | PROD. | REAL | | | | THIN | | |
|---|---|---|---|---|---|---|---|---|---|---|
| FARMS | LINEAGE | WEEKS | 01/22 | WEIGHT | CRACK | DEFORM. | FAILED | SHELL | DIRTY | POROUS |
| 2 | LOHMANN | 57 | 3.52 | 61.1 | 1 | 0 | 1 | 0 | 0 | 0 |
| | WHITE | | | | | | | | | |
| 4 | BOVANS | 21 | 0.58 | 53.5 | 0 | 0 | 0 | 0 | 0 | 0 |
| | WHITE | | | | | | | | | |
| 5 | BOVANS | 43 | 2.16 | 62.3 | 1 | 0 | 1 | 0 | 0 | 0 |
| | WHITE | | | | | | | | | |
| 7 | LOHMANN | 99 | −1.28 | 67.8 | 4 | 2 | 3 | 2 | 0 | 3 |
| | WHITE | | | | | | | | | |
| 9 | HISEX WHITE | 77 | 2.88 | 65.3 | 1 | 1 | 1 | 0 | 0 | 1 |
| 10 | LOHMANN | 85 | −2.36 | 66.6 | 3 | 5 | 2 | 1 | 0 | 2 |
| | WHITE | | | | | | | | | |
| AVERAGE | | 64 | 0.9 | 62.8 | 2.8 | 4.6 | 2.2 | 0.8 | 0.0 | 1.7 |

TECHNICAL VISIT 8 WEEKS LATER

| | | | | | | | | | | |
|---|---|---|---|---|---|---|---|---|---|---|
| 2 | LOHMANN | 65 | 3.44 | 60.5 | 0 | 0 | 0 | 0 | 0 | 0 |
| | WHITE | | | | | | | | | |
| 4 | BOVANS | 29 | 2.1 | 59.4 | 0 | 0 | 0 | 0 | 0 | 0 |
| | WHITE | | | | | | | | | |
| 5 | BOVANS | 51 | 2.21 | 61.5 | 0 | 0 | 0 | 0 | 0 | 0 |
| | WHITE | | | | | | | | | |
| 7 | LOHMANN | 107 | −1.15 | 64 | 2 | 2 | 0 | 1 | 0 | 1 |
| | WHITE | | | | | | | | | |
| 9 | HISEX WHITE | 85 | 2.18 | 61.6 | 0 | 1 | 0 | 0 | 0 | 0 |
| 10 | LOHMANN | 93 | −1.94 | 62.1 | 1 | 3 | 1 | 0 | 1 | 0 |
| | WHITE | | | | | | | | | |

### Example 4: Assessment of the Use of the Nutritional Supplement in Cattle Feed

### A) Slaughter Cattle—Paraná

The study was carried out with a total of 40 animals from a farm in the city of Prudentópolis, state of Paraná. In the study, 20 animals received feed containing 7 grams per day of the nutritional supplement of the present invention and 20 received feed without the nutritional supplement. The animals were slaughtered in 2 different slaughterhouses (Argus and Maria Macia), always in batches of 10 treated animals (positive control) against 10 witnesses (negative control).

The farmer's cost per animal was R$7.35 a month and the animals received the nutritional supplement for 3 months, with the resulting cost of R$22.05 per animal. In addition, the use of the nutritional supplement in the feed source improved carcass yield between 1.5% and above 2% which resulted in a profit, for the farmer, between R$197 and R$321 per livestock unit. The data obtained are depicted in the table below.

### B) Slaughter Cattle—São Paulo

Similar to the study conducted in the state of Parana, this study was carried out on 40 animals from a farm in the city of Registro, state of São Paulo. The animals received supplementation containing 7 grams per day of the nutritional supplement of the present invention. As a response, the animals showed a carcass yield 1.5% above the control.

The results show improved productivity of animals based on carcass measurements, demonstrating the efficacy of using the nutritional supplement comprising ricinoleic acid.

TABLE 10
Weight comparison of animals with and without
the use of the nutritional supplement.

| | | | MARIA MACIA | |
|---|---|---|---|---|
| ARGUS SLAUGHTERHOUSE | | | SLAUGHTERHOUSE | |
| | Animals (total: 20) | | Animals (total: 20) | |
| | Treatment | | Treatment | |
| | with polyol | Control | with polyol | Control |
| Carcass yield | 56.62% | 53.937% | 55.197% | 53.592% |
| Average live weight | 623 kg | 635 kg | 609 kg | 650.8 kg |
| Average carcass | 352.75 kg | 342.5 kg | 336.15 kg | 348.78 kg |
| weight | | | | |

### Example 5: Gas chromatography of ricinoleic acid composition

The results of the analysis of the content of the emulsifier obtained by gas chromatography coupled to mass spectrometry following the reference: A.O.A.C.-Official Methods of Analysis. 21st ed., 2019, 969.33, 996.06 and 963.22 are given below:
Saturated fatty acids, g/100 g . . . 2.18
Monounsaturated fatty acids, g/100 g. . . . 92.37.
Polyunsaturated fatty acids, g/100 g. . . . 5.45
Trans fatty acids, g/100 g. . . . not detected
C18:0 cis Palmitic acid, g/100 g. . . . 1.20
C18:0 cis Stearic acid, g/100 g. . . . 0.93
C18:1 cis Oleic acid, g/100 g. . . . 3.17
C18:1 cis-9-hydroxy-12 Ricinoleic acid, g/100 g. . . . 88.78
C18:2 cis Linoleic acid, g/100 g. . . . 4.99
C18:3 cis Linolenic acid, g/100 g. . . . 0.48
C20:1 cis Eicosenoic acid, g/100 g. . . . 0.42

The fatty acid profile shows the presence of ricinoleic acid as the majority and the presence of some other acids in much lower concentrations, which is coherent because ricinoleic acid is obtained from the saponification of castor oil, and the other acids are present as constituents of the triacylglycerides found in castor oil. It is noteworthy, however, the absence of ricinoleic acid, or any other derivative of ricinoleic acid, such as stolides.

Through hydrogen nuclear resonance spectrometry analysis of the product extracted from the emulsifier solution, it was also possible to identify that ricinoleic acid was the major product and that there was no polyol or stolide in the solution. The hydrogens in the region of 5.25 to 5.75 ppm refer to vinyl hydrogens, the signal in 3.50 to 3.75 ppm is referring to carbinolic hydrogen, the triplet in 2.35 is referring to the hydrogens neighboring the carboxyl group, in the region of 1.80 to 2.25 ppm the allyl hydrogens are observed and in the region of 0.75 to 1.75 ppm the other aliphatic hydrogens. The carboxyl and hydroxyl endings of the derivative of the emulsifying composition interact with the calcium and phosphorus ions, preventing them from binding generating insoluble salts, and allowing their absorption in the form of lipid micelles.

### Example 6: Healing of Fractures

Adequate phosphorus levels are essential for bone healing. Improved availability through the composition disclosed herein can support the healing process of fractures, promoting better recovery. Phosphorus, alongside calcium, is essential for maintaining bone density. Its improved availability can complement calcium's role in preventing and managing osteoporosis, essential for better aging and longevity. By improving the availability of calcium and phosphorus, the composition disclosed herein contributes to better bone health, enhanced physical performance, and overall well-being. Its diverse benefits, especially in promoting child development, aiding fracture healing, and supporting better aging and longevity, make it a valuable addition to various applications in human health and performance.

An 82-year-old woman is given 1 g of the nutritional supplement daily and with weak bone consolidation in her tibia, over a period of 30 days. The result is a remarkable improvement in bone consolidation, indicating the potential therapeutic benefits of the emulsifying composition.

### Example 7: Bioavailability Test of Emulsifying Composition

An evaluation of bioavailability is performed to measure pre-dose serum phosphorus and calcium analysis, with measurements taken at 4 intervals (30 minutes. 1 hour. 2 hours, and 3 hours) after dosing. Pharmacokinetic statistics and parameters such as cMax, tMax, and AUC for 0-3 hours, and standard statistical methods are used to assess changes from pre-dose to each time period. The data obtained from the study guides the development of future research and helps establish the product's efficacy and safety profile. These comprehensive tests and analyses provide valuable insights into the pharmacokinetics and efficacy of the nutritional supplement, supporting its distinctiveness as a new invention with potential benefits in various applications.

### Example 8: Outcomes of Administration of Emulsifying Composition

Positive outcomes are wide and varied of administrating the nutritional supplement disclosed herein. Several experimental techniques exemplify the efficacy and benefits of the nutritional supplement disclosed herein.

Serum Concentration Measurements: Blood tests can be used to measure the levels of calcium and phosphate in the serum. Although they do not directly measure absorption, they can indicate whether a person's intake and absorption of these minerals are adequate. A deficiency in serum levels could suggest poor absorption. However, these tests have limitations, as serum levels can be influenced by a variety of factors and may not reflect total body stores.

PROTOCOL: A cross-sectional study design would be suitable. A sample size of at least 30 participants will help ensure statistically significant results. The blood samples should be collected after a fast of 8 to 10 hours. The calcium and phosphate levels in the serum can be compared across different groups (e.g., individuals with different dietary habits, different doses) using an independent t-test or an ANOVA if there are more than two groups.

Balance Studies: In these studies, the amount of calcium or phosphate consumed (input) and the amount excreted (output) are measured over a certain period. The difference between input and output indicates the amount absorbed. However, this method can be time-consuming and requires careful sample collection.

PROTOCOL: These would typically be conducted as a longitudinal study, with each participant serving as their own control. A sample size of 10-20 participants is sufficient due to the high degree of control over dietary intake. The study should last for at least one week to ensure that intake and excretion are balanced. The daily balance (intake minus excretion) can be compared using a paired t-test or repeated-measures ANOVA.

Dual Stable Isotope Method: This is a more sophisticated technique, often considered the gold standard for assessing mineral absorption. In this method, two stable isotopes of calcium or phosphorus are administered, one orally and one intravenously. By measuring the ratio of these isotopes in blood or urine, the fraction of the dose that is absorbed can be calculated. This method can be more accurate, but it is also more complex and costly.

PROTOCOL: This is usually conducted as a crossover trial, where each participant receives both the oral and intravenous doses in a random order on separate occasions. At least 10 participants would be needed for reliable results. Urine and/or blood samples should be collected for at least 24 hours after each dose. The fractional absorption from each route can be compared using a paired t-test.

Imaging Tests: Technologies such as DXA (dual-energy x-ray absorptiometry) can measure bone mineral density and indirectly reflect calcium and phosphate absorption. This method is non-invasive and is commonly used to assess the risk of osteoporosis. However, it doesn't provide a real-time measurement of absorption.

PROTOCOL: A cross-sectional study design is suitable here too. A larger sample size (at least 50 participants) would be needed to account for the variability in bone mineral density. The DXA scans should be conducted in a single session to avoid variability due to time of day or diet. The bone mineral density can be compared across groups using an independent t-test or ANOVA.

Fractional Absorption Test: This test involves consuming a meal or supplement containing a known amount of calcium or phosphorus and then collecting urine for a certain number of hours. By measuring the concentration of the mineral in the urine, the fraction of the dose that was absorbed can be estimated.

PROTOCOL: A crossover trial would be suitable here, with each participant consuming the test meal or supplement on separate occasions. A sample size of 10-20 participants is usually sufficient. Urine should be collected for 24 hours after each test meal. The fractional absorption can be compared using a paired t-test.

### Example 9: Benefits of Ricinoleic Acid for Calcium Absorption

Advancements in preparation methods of ricinoleic acid salts have created final formulations which demonstrate superior absorption and distribution of calcium and phosphate in vivo. The room temperature saponification with sodium chloride generated a salt that was easily handled, stable over time, and interacts with food and beverages effectively to transport their calcium and phosphorous into the body of a human. Ricinoleic acid salts suffer from difficult handling and thus the unexpectedly easy preparation and formulation disclosed herein are a breakthrough for use of ricinoleic acid sodium salt in the diet of humans. Additionally, the volume and economic costs of varying concentrated versions of ricinoleic acid provide both economic and logistical advantages to feed of large volumes of animals. At lower concentrations, the physicochemical characteristics of the ricinoleic acid are more subtle and less prone to affect bulk qualities of food or nutrition but may take up more volume of a stock of animal feed. Across a farm, this may translate to a large saving in time, energy, and effort.

### Example 10: With Laying Hens

### Brief Description of the Experiment

This experiment involved the comparison of two different diets in laying hens, analyzing the production and quality of the eggs, as well as the bone health of the birds, using quantitative and qualitative methods of evaluation.

### Material and Methods:

Number of Animals: 330 laying hens.
Number of Groups: Two groups of 165 birds each.
Housing: Birds distributed in cages with a density of 5 hens per cage.

### Treatments:

CONTROL Diet: Offered to the group called Dicalcium Phosphate, containing dicalcium phosphate as the main source of phosphorus and calcium.
TEST Diet: Offered to the group called Less. The test diet comprised a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution) and a feed source which contained no addition of dicalcium phosphate.

Both diets contained phytase and both feed sources used the same basic ingredients, except for dicalcium phosphate as the sources of phosphorus and calcium in the control diet.

### Evaluations Performed:

Egg Production: Daily quantification using the Digital Egg Tester (Nabel Co).
Bone Radiopacity: Evaluation of femur and tibia mineralization by radiographic imaging in 12 randomly selected birds at 30, 60 and 90 weeks of age.

### Findings:

Egg Production: There was no statistically significant difference in the average egg production between the groups, both with an average of 327.46 eggs per bird from 24 to 76 weeks of age.
Egg Quality: No statistically significant differences were observed in relation to eggshell weight, strength, and thickness.
Bone Radiopacity: No visible differences in bone mineralization were observed between the groups in any of the periods analyzed.

TABLE 11
Statistical Results for laying hens

| | Age | Weight | Strength | Shell Thickness |
|---|---|---|---|---|
| Group | (weeks) | (g) | (Str) (Kgf) | (Thk) (mm) |
| Dicalcium Phosphate | 30 | 60.2 | 4.83 | 0.4 |
| Test | 30 | 59.7 | 4.68 | 0.41 |
| Dicalcium Phosphate | 60 | 63.0 | 4.47 | 0.4 |
| Test | 60 | 68.3 | 4.18 | 0.39 |

Conclusion: the use the nutritional supplement allowed for the removal of dicalcium phosphate from the diet, with no difference in any of the production parameters.

### Example 11—Swine Experiments

### Experiment 1:

### Category

### Sows and Piglets

### Experiment Location:

Palotina Campus of the Federal University of Paraná (UFPR PALOTINA)

### Brief Description of the Experiment

The study evaluated the impact of different levels of supplementation on the diet of sows during lactation and its subsequent effect on piglets during the nursery phase, totaling six different treatments focusing on feed intake, feed conversion and daily weight gain of the litter.

### Material and Methods:

### Number of Animals and Groups:

17 sows per treatment, totaling 3 groups.

After weaning, the piglets were allocated to six different treatments, according to the mother's diet.

### Treatments:

### Sows Groups:

In the experiment, the sows were divided into three groups, based on the amount of a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution), in the diet during lactation:
Group T1: Control Diet. No added nutritional supplement.
Group T2: 0.5 kg of nutritional supplement per ton of feed. Moderate addition of nutritional supplement.
Group T3: 1.0 kg of nutritional supplement per ton of feed. Highest amount of nutritional supplement.

Each group had 17 sows, totaling 51 sows in all.

### Piglet Groups

After weaning, the piglets were allocated into six groups according to the diet of the sows and were given nutritional supplement in the nursery at a ratio of 1 kg of nutritional supplement to 1 ton of feed. The combinations resulted in:
Group P1: Control x No nutritional supplement. Control piglets without post-weaning nutritional supplement.
Group P2: Control x With nutritional supplement. Control piglets with nutritional supplement post-weaning.
Group P3. 0.5 kg x No nutritional supplement. Piglets from sows with 0.5 kg of nutritional supplement per ton of feed, without post-weaning Nutritional supplement.
Group P4: 0.5 kg x With Nutritional supplement. Piglets from sows with 0.5 kg of nutritional supplement per ton of feed, with post-weaning nutritional supplement.
Group P5: 1.0 kg x Without Nutritional supplement. Sow piglets with 1.0 kg of nutritional supplement, without post-weaning Nutritional supplement.
Group P6: 1.0 kg x With Nutritional supplement. Piglets from 1.0 kg sows, with post-weaning nutritional supplement.

### Accommodation:

9 pens per treatment in the nursery phase, with 10 piglets per stall.

### Findings:

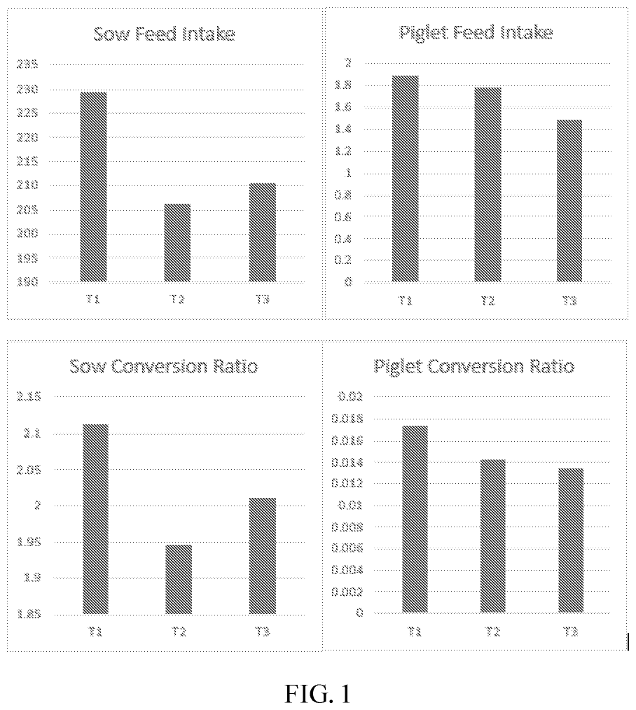

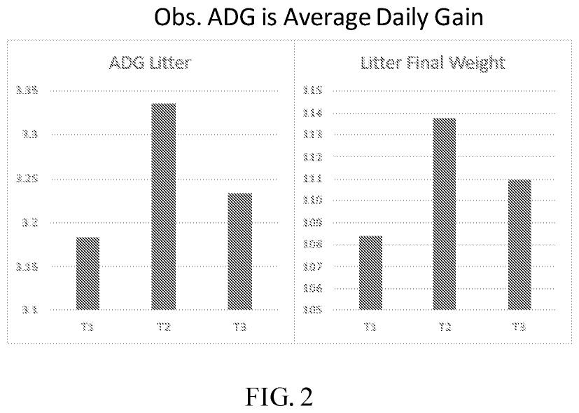

No statistically significant differences were observed between the treatments in terms of feed intake, but a trend towards lower intake and better feed conversion was observed in the treated groups of sows, with higher daily weight gain observed in the litters of the treated sows. FIG. 1 and FIG. 2 show the results of Table 12.

TABLE 12
Results of the sows experiment:

| Variable | T1 | T2 | T3 | SEM | p |
|---|---|---|---|---|---|
| Cycle | 2.41 | 2.41 | 2.91 | 0.24 | 0.203 |
| Pre-Partum Body Score | 14.27 | 13.87 | 14.27 | 0.332 | 0.24 |
| Number of Sows | 12 | 12 | 12 | — | — |
| Number of Piglets | 155 | 164 | 161 | 0.194 | 0.375 |
| Number of Piglets per Sow | 12.91 | 13.37 | 13.35 | 0.194 | 0.375 |
| Lactation Days* | 24.25/23.54 | 23.75/23.54 | 23.66/23.54 | — | — |
| Weaning Score | 12.03 | 11.86 | 12.16 | 0.341 | 0.84 |
| Initial Piglet Weight | 1.731 | 1.727 | 1.758 | 0.03 | 0.977 |
| Sow Feed Intake | 229.3 | 206.15 | 210.64 | 6.45 | 0.666 |
| Piglet Feed Intake | 1.891 | 1.777 | 1.479 | 0.261 | 0.554 |
| Sow Feed Conversion | 2.113 | 1.947 | 2.011 | 0.059 | 0.117 |
| Piglet Feed Conversion | 0.0173 | 0.0143 | 0.0134 | 0.002 | 0.772 |
| Daily Weight Gain of Litter | 3.184 | 3.336 | 3.234 | 0.065 | 0.78 |
| Initial Litter Weight | 22.44 | 23.65 | 23.62 | 0.478 | 0.494 |
| Final Litter Weight | 108.4 | 113.75 | 110.96 | 2.54 | 0.14 |

TABLE 13
Results of Piglets by Treatment (P1 to P6)

| Variable/Treatment | P1 | P2 | P3 | P4 | P5 | P6 | SEM | P |
|---|---|---|---|---|---|---|---|---|
| Weaning Weight (kg) | 8.172 | 8.108 | 7.67 | 8.169 | 8.066 | 8.06 | 0.061 | 0.19 |
| P1 (kg) | 9.85 | 9.52 | 9.65 | 9.56 | 9.51 | 9.57 | 0.065 | 0.25 |
| P2 (kg) | 12.46 | 12.23 | 12.04 | 12.24 | 12.32 | 12.4 | 0.081 | 0.527 |
| P3 (kg) | 116.54 | 16.43 | 15.97 | 16.4 | 16.2 | 16.66 | 0.104 | 0.756 |
| Weight at 35 days (kg) | 24.8 | 24.58 | 23.97 | 24.49 | 24.05 | 24.58 | 0.141 | 0.526 |
| GPD 1 | 0.258 | 0.212 | 0.231 | 0.218 | 0.21 | 0.219 | 0.003 | 0.129 |
| GPD 2 | 0.374ab | 0.384ab | 0.341b | 0.381ab | 0.401a | 0.404a | 0.004 | 0.001 |
| GPD 3 | 0.582ab | 0.598ab | 0.560ab | 0.594ab | 0.553b | 0.607a | 0.005 | 0.007 |
| GPD 4 | 0.635 | 0.627 | 0.616 | 0.623 | 0.604 | 0.609 | 0.005 | 0.694 |
| GPD nursery | 0.493 | 0.486 | 0.468 | 0.484 | 0.471 | 0.486 | 0.107 | 0.224 |
| ID 1 | 0.278 | 0.277 | 0.269 | 0.263 | 0.276 | 0.282 | 0.002 | 0.247 |
| ID 2 | 0.449ab | 0.480a | 0.405b | 0.461ab | 0.465ab | 0.478a | 0.006 | 0.021 |
| ID 3 | 0.713 | 0.688 | 0.68 | 0.698 | 0.663 | 0.683 | 0.009 | 0.67 |
| ID 4 | 0.863 | 0.873 | 0.86 | 0.888 | 0.815 | 0.831 | 0.009 | 0.34 |
| Average ID nursery | 0.624 | 0.631 | 0.608 | 0.633 | 0.601 | 0.615 | 0.005 | 0.302 |
| CA 1 | 1.131 | 1.399 | 1.173 | 1.239 | 1.321 | 1.300 | 0.027 | 0.247 |
| CA 2 | 1.231 | 1.231 | 1.196 | 1.238 | 1.174 | 1.207 | 0.02 | 0.863 |
| CA 3 | 1.263 | 1.122 | 1.221 | 1.176 | 1.211 | 1.119 | 0.018 | 0.437 |
| CA 4 | 1.407 | 1.379 | 1.414 | 1.425 | 1.354 | 1.367 | 0.015 | 0.939 |
| CA nursery | 1.293 | 1.283 | 1.304 | 1.31 | 1.279 | 1.261 | 0.009 | 0.649 |

Notes:
GPD: Daily Growth Rate.
ID: Intake to Weight Gain Ratio.
CA: Feed Conversion Ratio.

### Results Considering Piglets:

Piglet Performance: In general, piglets receiving the nutritional supplement performed better than untreated piglets. The best results were observed in piglets whose sows received the highest dose of the nutritional supplement (1 kg per ton). These piglets, in addition to receiving the nutritional supplement after weaning, showed significant improvements in parameters such as daily weight gain and feed conversion compared to the groups that did not receive supplementation or whose sows received lower doses.

### Conclusion:

The data indicate that supplementation with the nutritional supplement for both sows during lactation and piglets after weaning can significantly improve piglet performance, especially when both sows and piglets are treated with the highest dose tested.

### Experiment 2:

### Category:

### Growth and Termination

### Brief Description of the Experiment

This experiment investigated the impact of different levels of available phosphorus and a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution) on pigs during the growing and finishing phases. The diets ranged from 0.28% to 0.40% of available phosphorus, with adjustments to the amount of the nutritional supplement to optimize absorption. Results indicated that a moderate dose of available phosphorus with fine adjustments in the amount of the nutritional supplement improves weight gain and feed efficiency.

### Description of the Experimental Groups

TABLE 13
Description of the Experimental Groups in the Growth and Finishing Phases

| Treatments | Growth Phase | Finishing Phase |
|---|---|---|
| T1 | Control 0.4% Available Phosphorus | Control 0.4% Available Phosphorus |
| T2 | 0.36% Available Phosphorus | 0.36% Available Phosphorus |
| T3 | 0.32% Available Phosphorus | 0.32% Available Phosphorus |
| T4 | 0.28% Available Phosphorus | 0.28% Available Phosphorus + 0.250 kg |
| | | nutritional supplement |
| T5 | 0.28% Available Phosphorus + 1 kg | 0.28% Available Phosphorus |
| | nutritional supplement | |

### Findings:

TABLE 14
Zootechnical Performance During the Growth Phase with Decreasing Levels of Available
Phosphorus in the Diet, with or without the nutritional supplement.

| Variable/Treatment | T1 | T2 | T3 | T4 | T5 | SEM | p |
|---|---|---|---|---|---|---|---|
| Initial Weight (kg) | 26.67 | 26.24 | 26.44 | 26.95 | 26.68 | 0.167 | 0.730 |
| Weight at 58 days (kg) | 88.58ab | 90.52a | 89.24b | 88.95ab | 87.02b | 0.385 | 0.001 |
| Daily Weight Gain (kg) | 1.065bc | 1.106a | 1.077ab | 1.072abc | 1.039c | 0.004 | 0.005 |
| Average Intake (kg) | 133.47 | 132.80 | 133.47 | 133.93 | 132.67 | 1.070 | 0.996 |
| Feed Conversion Ratio (FCR) | 2.08 | 2.07 | 2.12 | 2.13 | 2.13 | 0.015 | 0.479 |

Notes:
The letters (a, b, c, ab, bc, abc) indicate statistical significance between treatments.
SEM: Standard Error of the Mean

### Description of Results

Higher daily weight gain (DWG) and significantly higher final weight were observed at T2 (0.36% of Available Phosphorus), as well as a trend towards better feed conversion.

Higher levels of Available Phosphorus (0.40%) at T1 did not result in better performance, corroborated by previous studies that also showed worse performance at extreme levels.

T5 showed results similar to those of T1, suggesting that the dose of 1 kg of Phosphorus Optimizing Emulsifier may have caused an excessive increase in Available Phosphorus.

### Changes in the Protocol for the Termination Phase:

T4 received only 250 g of Phosphorus the nutritional supplement per ton, while T5 served as a negative control, with no nutritional supplement. Adaptation was made due to the observation of worse performances when the Available Phosphorus added to the phosphorus matrix offered by the nutritional supplement exceeded the maximum value indicated.

TABLE 15
Zootechnical Performance During the Finishing Phase.

| Variable/Treatment | T1 | T2 | T3 | T4 | T5 | SEM | p |
|---|---|---|---|---|---|---|---|
| Initial Weight (kg) | 26.67 | 26.24 | 26.44 | 26.95 | 26.68 | 0.167 | 0.730 |
| Weight at 58 days (kg) | 88.58 | 90.52 | 89.24 | 88.95 | 87.02 | 0.385 | — |
| Weight at 102 days (kg) | 137.41bc | 140.03a | 138.78ab | 139.78ab | 136.62c | 0.503 | 0.023 |
| Daily Weight Gain (kg) | 1.105 | 1.115 | 1.110 | 1.139 | 1.119 | 0.009 | 0.577 |
| Average Intake (kg) | 122.06 | 121.47 | 122.38 | 121.25 | 123.83 | 0.702 | 0.808 |
| Feed Conversion Ratio (FCR) | 2.43 | 2.46 | 2.51 | 2.41 | 2.50 | 0.023 | 0.604 |

Notes:
DGR: Daily Growth Rate
FCR: Feed Conversion Ratio
The letters (a, b, c, ab, bc) indicate statistical significance among treatments. The calculation period was from 58 to 102 days of housing.
T4 contains 250 g/ton of the nutritional supplement.

### Description of Results

Body weight at 102 days was significantly higher at T2, T4 and T3, in that order.

At T4, in addition to a final weight similar to that of T2, there was a trend towards higher GPD and lower mean intake and feed conversion, indicating that a reduced dose of the nutritional supplement can optimize the absorption of Available Phosphorus efficiently.

### Conclusions:

The experiment demonstrated that adjustments in the dose of the nutritional supplement are crucial as pigs grow, suggesting that the action of the emulsifier is proportional to the weight of the animals. Reducing the dose of the emulsifier as the pigs progress to the finishing phase has proven to be an effective strategy, maintaining efficiency in the absorption of available phosphorus without excesses that could impair performance.

### Example 12—Experiment with Broilers

### Location:

Federal University of Paraná, Palotina campus

### Category:

### Growth and Termination

### Brief Description of the Experiment

This study evaluated the impact of different calcium-phosphorus ratios in the diet of broilers, including the addition of a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution), on growth, feed intake, and bone strength throughout various stages of development.

### Experimental Design:

### Number of Birds:

1548 male chicks of the Cobb lineage, distributed equally among four treatments.

### Treatments:

T1/A: Phytase only (negative control).
T2/B: With recommended calcium-phosphorus ratio of 1.65:1 (positive control).
T3/C: With a calcium-phosphorus ratio of 2:1.
T4/D: With the nutritional supplement, calcium, and phosphorus ratio of 1.65:1.

### Setup:

4 treatments×9 replicates×43 birds per box=1548 birds.

TABLE 16
Zootechnical Performance Results from 1 to 42 Days of Age.

| Variable/Treatment | T1 (A) | T2 (B) | T3 (C) | T4 (D) | CV, % | p-Value |
|---|---|---|---|---|---|---|
| Live Weight (g) | 3061.57b | 3295.87a | 3307.19a | 3223.06a | 3.38 | 0.0001 |
| Feed Consumption (g) | 5018.88b | 5443.35a | 5482.00a | 5364.28a | 4.31 | 0.0006 |
| Weight Gain (g) | 3035.51b | 3262.11a | 3295.92a | 3186.69a | 3.43 | <0.0001 |
| Feed Conversion Ratio | 1.654a | 1.669a | 1.663a | 1.684a | 3.26 | 0.6947 |

The table shows that the treatment with a calcium to phosphorus ratio of 1.65:1, including the nutritional supplement, yielded results comparable to the positive controls, demonstrating that it is possible to optimize the formulation without compromising zootechnical performance.

TABLE 17
Bone Strength at 7, 21, 28, and 42 Days.

| Age (days) | Variable | T1 (A) | T2 (B) | T3 (C) | T4 (D) | CV, % | p-Value |
|---|---|---|---|---|---|---|---|
| 7 | Femur (kg) | 2.72c | 4.43ab | 4.67a | 3.81b | 21.46 | <0.0001 |
| | Tibia (kg) | 2.17b | 3.41a | 3.52a | 2.94a | 22.02 | <0.0001 |
| 21 | Femur (kg) | 15.37b | 22.98a | 23.22a | 21.33a | 20.91 | <0.0001 |
| | Tibia (kg) | 16.51b | 21.85a | 21.27a | 19.85ab | 19.58 | 0.0004 |
| 28 | Femur (kg) | 19.62b | 27.42a | 27.38a | 25.84a | 18.88 | 0.0012 |
| | Tibia (kg) | 26.65b | 30.66ab | 32.23a | 30.78ab | 17.16 | 0.0131 |
| 42 | Femur (kg) | 30.23b | 37.46a | 39.12a | 37.04a | 17.16 | 0.0003 |
| | Tibia (kg) | 43.06b | 51.72a | 49.81ab | 44.88ab | 19.18 | 0.0197 |

The results indicate that, even with a reduction in phosphate inclusion when the nutritional supplement was included, bone strength was similar to or better than the controls, especially in treatments with an optimized calcium to phosphorus ratio.

### Example 13-Preliminary Results with Ruminants: Beef Cattle

### Location

Guapiara Farm, Mato Grosso do Sul, Brazil

### Species Used:

Beef Cattle

### Category:

Finishing (Feedlot)

### Brief Description of the Experiment

This study evaluated the impact of supplementation with a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution) on the daily weight gain of feedlot cattle. The experiment compared the performance of cattle treated with the nutritional supplement against a control group without supplementation.

### Experimental Design:

### Number of Animals:

Total of 166 steers, with 84 in the treated group and 82 in the control group.

### Treatments:

Control: Animals without supplementation.
Treated: Animals received the nutritional supplement at a dosage of 15 g per head per day.

### Treatment Duration:

80 days until the first weighing.

The test is still in progress and the final result will have data on weight gain, feed conversion and carcass yield at slaughter.

### Experiment Results:

TABLE 18
Weight Gain in Beef Cattle.

| Variable | Control | | Treated | Difference |
|---|---|---|---|---|
| Total Weight Gain (kg) in 80 days | 133.6 | kg | 142 kg | +8.4 kg |
| Average Daily Weight Gain (g) | +1.670 | g | +1.775 | +0.105 |

The results demonstrate that cattle treated with the nutritional supplement had a higher average daily weight gain of 105 grams compared to the control group, indicating a significant improvement in the zootechnical performance of the supplemented animals. The difference in total weight gain over the 80 days was 8.4 kg in favor of the treated group.

Experiment with Lambs

### Location:

State University of Londrina, Parana, Brazil

### Species Used:

Lambs

### Category:

Finishing (Feedlot)

### Brief Description of the Experiment

This study evaluated the impact of supplementation with a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution) on the daily weight gain of feedlot lambs. The experiment compared the performance of lambs treated with the nutritional supplement and normal (0.42% P) or lower (0.26% P) inclusion of dicalcium phosphate against a control group without supplementation, and with normal (0.42% P) or lower (0.26%) level of phosphorus.

### Experimental Design:

### Number of Animals:

Total of 32 lambs (50% males, 50% females), with 8 repetitions per treatment.

### Treatments:

Positive Control: Animals without supplementation, 0.42% P.
Negative Control: Animals without supplementation, 0.26% P.
Treated: Animals receiving the nutritional supplement at a dosage of 0.05% of the diet.

### Treatment Duration:

82 days until the final weighing.

### Experiment Results:

TABLE 19
Performance and feed efficiency of Dorper × Santa Inês lambs fed in feedlot with
diet containing two levels of phosphorus, with and without the inclusion of the nutritional supplement.

| | | The Nutritional Supplement | | | | | | |
|---|---|---|---|---|---|---|---|---|
| | Phosphorus | (g/kg MS) | | | | Value P^{III} | | |
| Variable^{I} | (% MS) | 0 | 0.5 | Average | SEM^{II} | Phosphorus | NS | P × GB |
| Initial Weight | 0.26 | 18.71 | 18.74 | 18.73 | 0.95 | 0.237 | 0.963 | 0.946 |
| (kg) | 0.42 | 20.67 | 20.49 | 20.58 | | | | |
| | Average | 19.69 | 19.62 | 19.65 | | | | |
| Final Weight | 0.26 | 29.89 | 30.60 | 30.25 | 1.13 | 0.327 | 0.220 | 0.942 |
| (kg) | 0.42 | 30.45 | 31.25 | 30.85 | | | | |
| | Average | 30.17 | 30.93 | 30.55 | | | | |
| ADG | 0.26 | 123.3 | 132.1 | 127.7 | 3.9 | 0.327 | 0.220 | 0.942 |
| (g/dia) | 0.42 | 130.2 | 140.0 | 135.1 | | | | |
| | Average | 126.8 | 136.0 | 131.4 | | | | |
| ADI | 0.26 | 799.8 | 786.0 | 792.9 B | 30.9 | 0.008 | 0.928 | 0.675 |
| (g/dia) | 0.42 | 870.2 | 879.0 | 874.6 A | | | | |
| | Average | 835.0 | 832.5 | 833.7 | | | | |
| ADIbw | 0.26 | 3.22 | 3.16 | 3.19 B | 0.06 | 0.002 | 0.658 | 0.808 |
| (% BW/dia) | 0.42 | 3.50 | 3.48 | 3.49 A | | | | |
| | Average | 3.36 | 3.32 | 3.34 | | | | |
| FCR | 0.26 | 6.49 | 5.95 | 6.22 | 0.17 | 0.268 | 0.048 | 0.824 |
| (kg DMI/kg | 0.42 | 6.71 | 6.27 | 6.49 | | | | |
| gain) | Average | 6.60 a | 6.11 b | 6.35 | | | | |
| GFE | 0.26 | 155.94 | 172.39 | 164.16 | 4.09 | 0.175 | 0.025 | 0.450 |
| (g gain/kg DMI) | 0.42 | 152.39 | 161.12 | 156.75 | | | | |
| | Average | 154.16 b | 166.75 a | 160.46 | | | | |
| BCS | 0.26 | 3.27 | 3.29 | 3.28 | 0.10 | 0.681 | 0.683 | 0.549 |
| (1 a 5 points) | 0.42 | 3.29 | 3.13 | 3.21 | | | | |
| | Average | 3.28 | 3.21 | 3.25 | | | | |

^{I}ADG: average daily gain; DMI: dry matter intake; DMIbw: dry matter intake as percentage of body weight; GFE: gross feed efficiency; FCR: feed conversion rate; BCS: body condition score
^{II}SEM: standard error of the mean
^{III}P: phosphorus; NS: The nutritional supplement
Lowercase letters in the row and uppercase letters in the column compare the averages by the F-test (P < 0.05).

The addition of the nutritional supplement in the amount of 0.5 g/kg NS to the diet improves the feed efficiency of lambs finished in feedlot, regardless of the P content of the diet.

### Example 14—The Nutritional Supplement as in Humans

### Experiment 1

### Introduction

The nutritional supplement is a scientifically developed product designed to optimize the absorption of essential minerals such as calcium and phosphorus. While its efficacy has been demonstrated in various animal studies, recent data indicate its potential benefits for human health. Methodology:

The study involved administering a nutritional supplement of the present disclosure (20 wt % emulsifier solution. 35 wt % diatomaceous earth and 45 wt % calcium carbonate of the nutritional supplement, where the emulsifier solution contained 23.6 wt % Sodium Ricinolate. 2.55 wt % NaOH, and 73.83 wt % water of the emulsifier solution) to human subjects over a specified period, with dosage adjustments to assess its impact on calcium and phosphorus levels. The administration protocol was as follows:
From Sep. 1, 2023, to May 14, 2024: 1.5 grams of the nutritional supplement every three days.
From May 14, 2024, to Jun. 22, 2024: 1.5 grams of the nutritional supplement daily.

### Results:

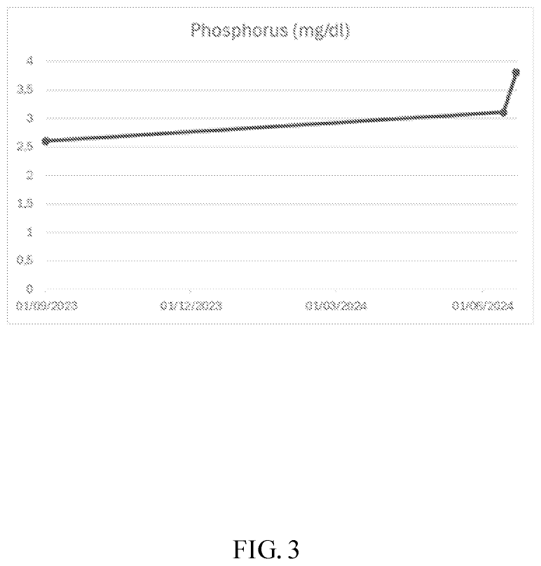

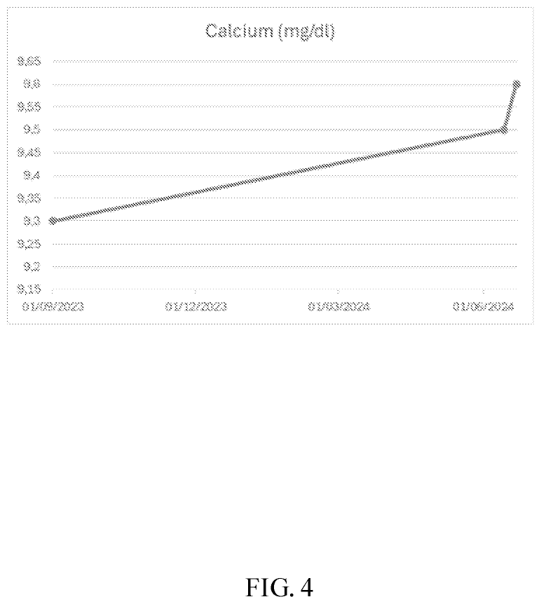

FIG. 3-4 illustrate the changes in serum calcium and phosphorus levels over the study period.

### Phosphorus Levels:

Initial phosphorus level on Sep. 1, 2023, was 2.8 mg/dL, within the reference range of 2.4 to 5.1 mg/dL. By May 14, 2024, the level increased to 3.1 mg/dL, and further to 3.8 mg/dl by Jun. 22, 2024. This consistent increase indicates improved phosphorus absorption with the nutritional supplement administration. Results are shown in FIG. 3.

### Calcium Levels:

Initial calcium level on Sep. 1, 2023, was 9.3 mg/dL, within the reference range of 8.3 to 10.6 mg/dL. The level slightly increased to 9.5 mg/dL by May 14, 2024, and maintained at 9.6 mg/dL by Jun. 22, 2024. This stability within the optimal range highlights the effectiveness of the nutritional supplement in maintaining adequate calcium levels.

### Ionized Calcium Levels:

Ionized calcium level measured on May 14, 2024, was 1.33 mmol/L, and slightly decreased to 1.32 mmol/L by Jun. 22, 2024. Despite this slight decrease, the ionized calcium level remained within the reference range of 1.16 to 1.32 mmol/L. This slight reduction suggests a potential increase in calcium retention in bones, as observed in similar tests conducted on birds. Results are shown in FIG. 4.

### Ionized Calcium Levels:

Ionized calcium level measured on May 14, 2024, was 1.33 mmol/L, and slightly decreased to 1.32 mmol/L by Jun. 22, 2024. Despite this slight decrease, the ionized calcium level remained within the reference range of 1.16 to 1.32 mmol/L. This slight reduction suggests a potential increase in calcium retention in bones, as observed in similar tests conducted on birds.

### Vitamin D Levels:

The vitamin D level was 67.0 ng/ml on Jan. 12, 2023, and decreased to 44.3 ng/mL by Jun. 22, 2024. Despite this reduction, calcium and phosphorus levels increased, indicating that the nutritional supplement effectively enhances the absorption of these minerals independently of vitamin D supplementation.

### Conclusion:

The data demonstrate a significant enhancement in both calcium and phosphorus absorption with the use of the nutritional supplement. Additionally, the slight decrease in ionized calcium levels, while still within the normal range, may indicate increased calcium retention in bones, aligning with findings from avian studies.

The increase in calcium and phosphorus levels, despite the decrease in vitamin D, underscores the nutritional supplement efficacy in optimizing mineral absorption independently of vitamin D supplementation. These findings are critical for establishing its efficacy in humans, justifying the need for patent protection. The improvements in mineral absorption underscore the nutritional supplement potential to address deficiencies and support overall health.

### Experiment 2

### Test Protocol

Three individuals were selected to be test participants (Subject 1, Subject 2, and Subject 3). Test participants fasted for 8 hours before the tests. Baseline levels of total calcium and phosphorus were measured. Each test participant received 500 mg of calcium and 500 mg of phosphorus. Measurements were taken at 30, 60, 120, and 180 minutes after supplement administration. Each test participant completed the protocol once without and once with the addition of 2 grams of a nutritional supplement of the present disclosure (20 wt % emulsifier solution, 35 wt % diatomaceous earth and 45 wt % calcium carbonate of the nutritional supplement, where the emulsifier solution contained 23.6 wt % Sodium Ricinolate, 2.55 wt % NaOH, and 73.83 wt % water of the emulsifier solution) which was administered along with the calcium and phosphorus doses.

### Observed Results

TABLE 20
Effect of the nutritional supplement on test participants.

| | | Total | Total | | Total | | |
|---|---|---|---|---|---|---|---|
| | | Baseline | Max | Total | Baseline | Total Max | Total |
| | | Calcium | Calcium | Calcium | Phosphorous | phosphorous | Phosphorous |
| Subject | Treatment | (mg/dL) | (mg/dL) | Change | (mg/dL) | (mg/dL) | Change |
| 1 | No Supplement | 9.2 | 9.9 | 7.61% | 2.8 | 3.5 | 25.00% |
| 1 | With | 9.2 | 9.9 | 7.61% | 2.5 | 3.2 | 28.00% |
| | Supplement | | | | | | |
| 2 | No Supplement | 9.8 | 10.2 | 4.08% | 2.8 | 3.3 | 17.86% |
| 2 | With | 10.2 | 11.2 | 9.80% | 3.4 | 4 | 17.65% |
| | Supplement | | | | | | |
| 3 | No Supplement | 10.1 | 10.5 | 3.96% | 3.3 | 3.9 | 18.18% |
| 3 | With | 10.2 | 10.7 | 4.90% | 2.9 | 4 | 37.93% |
| | Supplement | | | | | | |

### Interpretation of Results

### Subject 1

No difference in total calcium change (7.61%) with and without the nutritional supplement. Phosphorus increased by 28.00% with the nutritional supplement compared to 25.00% without.

### Subject 2

Higher increase in total calcium with the nutritional supplement (9.80% vs 4.08%). Similar phosphorus change (17.65% with vs 17.86% without).

### Subject 3

Slightly higher increase in total calcium with the nutritional supplement (4.90% vs 3.96%). Significant increase in phosphorus with the nutritional supplement (37.93% vs 18.18%).

### CONCLUSION

The results suggest that the nutritional supplement positively impacts calcium and phosphorus absorption, particularly in Subject 2 and Subject 3.

While preferred embodiments of the present disclosure have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-171. (canceled)

172. A method of feeding an animal, comprising providing to the animal a diet, wherein the diet comprises a feed source and a nutritional supplement;
wherein the nutritional supplement comprises:
(a) an emulsifier solution; and
(b) optionally one or more carriers,
wherein the emulsifier solution comprises:
(i) an emulsifier, said emulsifier comprising a compound or salt thereof having the structural formula of Formula (I), or a salt thereof: 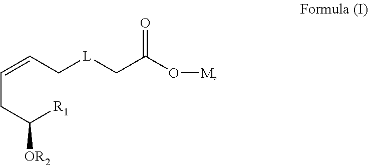
wherein,
R₁ is C₁-C₇ alkyl, which is optionally substituted with one or more C₁-C₇ alkyl;
R₂ is hydrogen, sodium, or calcium;
M is a cation selected from the group consisting of Ca, Na, Li, P, and
Mg; and
L is C₂-C₇ alkyl, which is optionally substituted with one or more groups selected from C₁-C₇ alkyl and —OH;
(ii) sodium hydroxide (NaOH); and
(iii) optionally water;
wherein the feed source comprises less calcium or phosphorous than a control feed source without the emulsifier,
wherein the animal consuming the feed source comprising less calcium or phosphorous and the emulsifier solution displays the same or enhanced level of at least one nutrition indicator relative to the animal consuming the control feed source without the emulsifier solution;
and wherein the diet comprises less than about 0.2 percent of the emulsifier by weight of the diet.

173. The method of claim 172, wherein in Formula (I), the compound is further defined as:

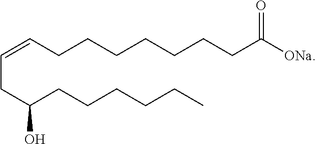

174. The method of claim 172, wherein the compound of Formula (I) is in the form of a calcium salt, a sodium salt, a lithium salt, a phosphorus salt, a potassium salt, a magnesium salt, a zinc salt, a manganese salt, a copper salt, an iron salt, a cobalt salt, or any combination thereof.

175. The method of claim 172, wherein the emulsifier solution is present in the amount of about 10 percent to 30 percent by weight of the nutritional supplement.

176. The method of claim 175, wherein the emulsifier solution is present in the amount of about 20 percent by weight of the nutritional supplement.

177. The method of claim 172, wherein the emulsifier solution comprises about 1 to about 50 percent of the compound of Formula (I), about 1 to about 10 percent sodium hydroxide, and about 25 to about 99 percent water by weight of the emulsifier solution.

178. The method of claim 177, wherein the emulsifier solution comprises about 24 percent of the compound of Formula (I), about 3 percent sodium hydroxide, and about 74 percent water by weight of the emulsifier solution.

179. The method of claim 172, wherein the emulsifier solution comprises about 50 to 100 percent of the compound of Formula (I), about 0 to 10 percent sodium hydroxide, and about 0 to about 10 percent water by weight of the emulsifier solution.

180. The method of claim 179, wherein the emulsifier solution comprises about 75 to about 99 percent of the compound of Formula (I), about 1 to 5 percent sodium hydroxide, and about 0 percent water by weight of the emulsifier solution.

181. The method of claim 172, wherein the nutritional supplement comprises the at least one or more carriers.

182. The method of claim 181, wherein the at least one or more carriers comprises at least one or more sources of silica or at least one or more sources of calcium.

183. The method of claim 182, wherein the one or more sources of silica is present in an amount of about 30 to about 40 percent by weight of the nutritional supplement.

184. The method of claim 182, wherein the one or more sources of calcium is present in an amount of about 40 to about 50 percent by weight of the nutritional supplement.

185. The method of claim 172, wherein the feed source is animal feed.

186. The method of claim 185, wherein the animal feed comprises poultry feed, swine feed, aquatic animal feed, or ruminant feed.

187. The method of claim 172, wherein the nutritional supplement is present in a ratio of the nutritional supplement to the feed source of about 0.2 kg nutritional supplement per ton of the feed source to about 1.5 kg of the nutritional supplement per ton of the feed source.

188. The method of claim 172, wherein the nutritional supplement is present at about 0.01 to about 0.5 percent weight relative to the weight of the feed source.

189. The method of claim 172, wherein the feed source does not contain meat or bone meal or dicalcium phosphate or any other source of phosphorus.

190. The method of claim 172, wherein the at least one nutrition indicator comprises weight gain, egg shell quality, carcass yield, average live weight, average carcass weight, bone fracture healing rate, blood serum calcium or phosphate levels, decreased levels of calcium or phosphate in excreta, bone radiopacity, egg production, egg quality, feed conversion rate, daily weight gain, final litter weight, meat quality score, average weight daily gain, feed efficiency, body condition score, ionized calcium levels, vitamin D levels, reproductive parameters, fertility, prolificity, ease of birth, reduction of problems associated with pregnancy, reduction of problems associated with delivery, reduction in issues with prolapses, reduction in issues with placenta retention, or any combination thereof.

191. The method of claim 172, wherein the animal is a ruminant, a poultry, a swine, an aquatic animal, or a human.

192. The method of claim 191, wherein the ruminant is administered about 0.01 kg to about 60 kg of the diet per day or the ruminant is administered about 0.1 g to about 60 g of the nutritional supplement per day.

193. The method of claim 191, wherein the ruminant is a steer, a beef producing ruminant, a milk producing ruminant, a lamb, a sheep, a ram, a kid, a goat, a buck, or a small ruminant.

194. The method of claim 193, wherein the method further increases the production of milk in the ruminant, increases the growth of meat in weight in the ruminant, increased fertility, ease of birth, or any combination thereof.

195. The method of claim 191, wherein the poultry is administered about 0.005 kg to about 0.2 kg of the diet per day.

196. The method of claim 191, wherein the poultry is a broiler poultry, a laying hen, a breeding poultry, a quail, a duck, a mallard, or a turkey.

197. The method of claim 191, wherein the method further increases the frequency of egg production, increases the egg quality, increases the growth of meat in weight in the poultry, increases the bone radiopacity in the poultry, increases bone strength in the poultry, or any combination thereof.

198. The method of claim 191, wherein the swine is administered about 0.075 g to about 12 kg of the diet per day or the swine is administered about 0.075 g to about 12 g of the of the nutritional supplement per day.

199. The method of claim 191, wherein the swine is a sow, a piglet, a hog, a boar, or a gilt.

200. The method of claim 191, wherein the method further increases the volume of milk produced by the swine, improves the quality of milk produced by the swine, increases the growth of meat in weight in the swine, or any combination thereof.

201. The method of claim 191, wherein the human is administered about 0.1 g to about 3.5 g of the nutritional supplement per day.
